(19) United States
(12) Patent Application Publication
(10) Pub. No.: US 2026/0172079 A1
(43) Pub. Date: Jun. 18, 2026

(54) METHOD FOR DETERMINING FULLY-COHERENT TRANSMISSION CODEBOOK FOR UPLINK MIMO TRANSMISSION AND COMMUNICATION DEVICE

(71) Applicant: Beijing Xiaomi Mobile Software Co., Ltd., Beijing (CN)

(72) Inventor: Zhenyu ZHANG

(73) Assignee: Beijing Xiaomi Mobile Software Co., Ltd., Beijing (CN)

(21) Appl. No.: 19/128,443

(22) PCT Filed: Nov. 9, 2022
(86) PCT No.: PCT/CN2022/130943

§ 371 Date: May 8, 2025

(51) Int. Cl. H04B 7/0456; H04B 7/06; H04W 72/21

(52) U.S. Cl. CPC H04B 7/0456; H04B 7/0634; H04W 72/21

(57) ABSTRACT

A method for determining a fully-coherent transmission codebook for uplink multiple input multiple output (MIMO) transmission, including: determining a first candidate codeword and a second candidate codeword from a candidate codebook of fully-coherent transmission using four antenna ports for the uplink MIMO transmission; determining, based on orthogonality of candidate codewords in the candidate codebook, a constraint condition that a common phase coefficient needs to meet; determining the common phase coefficient based on the constraint condition; and determining, by concatenating the first candidate codeword and the second candidate codeword according to the common phase coefficient, fully-coherent transmission codewords for L layers using eight antenna ports for the uplink MIMO transmission, where L is a positive integer and is less than or equal to 8.

### CROSS-REFERENCE TO RELATED APPLICATION

The present application is a U.S. National Stage of International Application No. PCT/CN2022/130943, filed on Nov. 9, 2022, the contents of all of which are incorporated herein by reference in their entireties for all purposes.

### BACKGROUND OF THE INVENTION

A precoding technology in a multiple input multiple output (MIMO) system can effectively reduce interference and system overheads and increase a system capacity, and is an extremely important key technology in the MIMO system. A codebook design is an important part of the precoding technology in the MIMO system based on codebook transmission.

### SUMMARY OF THE INVENTION

The present application relates to the technical field of communications, and in particular, to a method for determining a fully-coherent transmission codebook using eight antenna ports for uplink MIMO transmission and a communication device.

According to a first aspect, an embodiment of the present application provides a method for determining a fully-coherent transmission codebook using the eight antenna ports for the uplink MIMO transmission. The method includes:
determining a first candidate codeword and a second candidate codeword from a candidate codebook of fully-coherent transmission using four antenna ports for the uplink MIMO transmission;
determining, based on orthogonality of candidate codewords in the candidate codebook, a constraint condition that a common phase coefficient needs to meet, and determining the common phase coefficient based on the constraint condition; and
determining, by concatenating the first candidate codeword and the second candidate codeword according to the common phase coefficient, the fully-coherent transmission codewords for L layers using the eight antenna ports for the uplink MIMO transmission, where L is a positive integer and is less than or equal to 8.

According to a second aspect, an embodiment of the present application provides a communication device. The communication device includes one or more processors and a memory, where the memory stores a computer program. The one or more processors are collectively configured to execute the computer program stored in the memory to cause the communication device to perform the method according to the first aspect.

According to a third aspect, an embodiment of the present application provides a communication device. The communication device includes one or more processors and an interface circuit. The interface circuit is configured to receive code instructions and transmit the code instructions to the one or more processors. The one or more processors are collectively configured to run the code instructions to cause the communication device to perform the method according to the first aspect.

According to a fourth aspect, an embodiment of the present invention provides a non-transitory computer-readable storage medium for storing instructions for use by the terminal device. The instructions, when executed, cause the terminal device to perform the method according to the first aspect.

### BRIEF DESCRIPTION OF DRAWINGS

In order to describe the technical solution in embodiments of the present application or in the background more clearly, the accompanying drawings to be used in the embodiments of the present application or in the background are described below.

FIG. 1 is a schematic architectural diagram of a communication system according to an embodiment of the present application;

FIG. 2 is a schematic flowchart of a method for determining fully-coherent transmission codebook using eight antenna ports for uplink MIMO transmission according to an embodiment of the present application;

FIG. 3 is a schematic flowchart of a method for determining fully-coherent transmission codebook using eight antenna ports for uplink MIMO transmission according to another embodiment of the present application;

FIG. 4 is a schematic flowchart of a method for determining fully-coherent transmission codebook using eight antenna ports for uplink MIMO transmission according to another embodiment of the present application;

FIG. 5 is a schematic flowchart of a method for determining fully-coherent transmission codebook using eight antenna ports for uplink MIMO transmission according to another embodiment of the present application;

FIG. 6 is a schematic flowchart of a method for determining fully-coherent transmission codebook using eight antenna ports for uplink MIMO transmission according to another embodiment of the present application;

FIG. 7 is a schematic flowchart of a method for determining fully-coherent transmission codebook using eight antenna ports for uplink MIMO transmission according to another embodiment of the present application;

FIG. 8 is a schematic flowchart of a method for determining fully-coherent transmission codebook using eight antenna ports for uplink MIMO transmission according to another embodiment of the present application;

FIG. 9 is a schematic flowchart of a method for determining fully-coherent transmission codebook using eight antenna ports for uplink MIMO transmission according to another embodiment of the present application;

FIG. 10 is a schematic flowchart of a method for determining fully-coherent transmission codebook using eight antenna ports for uplink MIMO transmission according to another embodiment of the present application;

FIG. 11 is a schematic flowchart of a codebook-based uplink transmission method according to an embodiment of the present application;

FIG. 12 is a schematic flowchart of a codebook-based uplink transmission method according to another embodiment of the present application;

FIG. 13 is a schematic structural diagram of a communication device according to an embodiment of the present application;

FIG. 14 is a schematic structural diagram of a communication device according to an embodiment of the present application; and

FIG. 15 is a schematic structural diagram of a chip according to an embodiment of the present application.

### DETAILED DESCRIPTION OF THE INVENTION

Examples will be described in detail herein, examples of which are represented in the accompanying drawings. When the following description relates to the accompanying drawings, same numerals in different accompanying drawings denote same or similar elements, unless otherwise indicated. The implementations described in the following examples do not represent all the implementations consistent with the present disclosure. Rather, they are merely examples of devices and methods that are consistent with some aspects of the present disclosure and are described in detail in the appended claims.

The terms used in the embodiments of the present disclosure are merely for the purpose of describing specific embodiments, and are not intended to limit the embodiments of the present disclosure. The singular forms of “a”/“an”, and “the” used in the embodiments of the present disclosure and the appended claims are also intended to include plural forms, unless the context clearly indicates other meanings. It is also to be understood that the term “and/or” used herein refers to and includes any or all possible combinations of one or more associated listed items.

It is to be understood that although the terms such as first, second, and third may be used in the embodiments of the present disclosure to describe various pieces of information, the information should not be limited to these terms. These terms are merely used to distinguish the same type of information from each other. For example, without departing from the scope of the embodiments of the present disclosure, first information may also be referred to as second information, and similarly, the second information may also be referred to as the first information. Depending on the context, for example, the term “if” used here may be explained as “when” or “while” or “in response to determining that”. For the purpose of simplicity and ease of understanding, the terms used here to characterize size relationships are “greater than” or “less than”, and “higher than” or “lower than”. However, for a person skilled in the art, it may be understood that, the term “greater than” also covers the meaning of “greater than or equal to”, and “less than” also covers the meaning of “less than or equal to”; and the term “higher than” covers the meaning of “higher than or equal to”, and “lower than” also covers the meaning of “lower than or equal to”.

For ease of understanding, the terms involved in the present application are first introduced.

A physical uplink shared channel (PUSCH) is used to carry data from a transport channel PUSCH.

Coherent transmission is defined as a capability of an UE, and a coherent transmission capability of the UE includes:

Fully coherent transmission: all antenna ports are capable of coherent transmission.

Partially coherent transmission: antenna ports in a same coherent transmission group are capable of coherent transmission, and antenna ports in different coherent transmission groups are incapable of coherent transmission, where each coherent transmission group includes at least two antenna ports.

Non coherent transmission: there is no antenna port capable of coherent transmission.

Through the method for determining the fully-coherent transmission codebook using the eight antenna ports for the uplink MIMO transmission according to an embodiment of the present application, an antenna fully-coherent transmission codebook applicable to a communication system is determined. The communication system to which the embodiments of the present application are applicable is first described below.

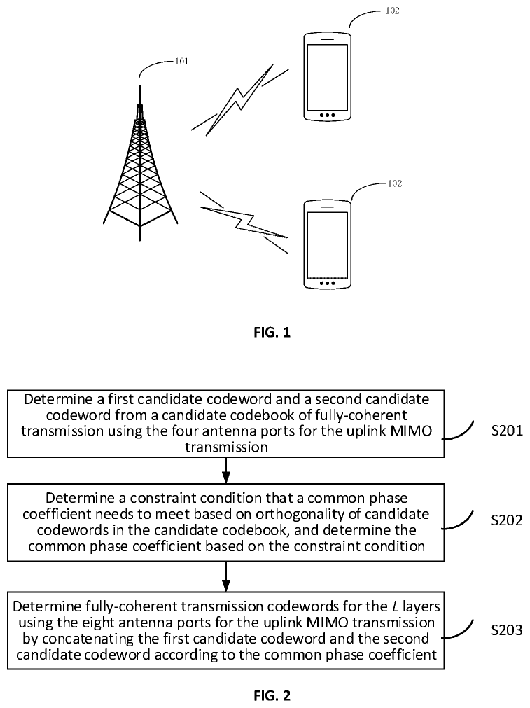

Referring to FIG. 1, FIG. 1 is a schematic architectural diagram of a communication system according to an embodiment of the present application. The communication system may include, but is not limited to, one network device and one terminal device. A number and form of the devices shown in FIG. 1 are merely as examples and do not constitute a limitation on the embodiments of the present application. In actual application, the communication system may include two or more network devices and two or more terminal devices. The communication system shown in FIG. 1 including one network device 101 and one terminal device 102 is used as example.

It should be noted that, the technical solution in the embodiments of the present application may be applied to various communication systems, for example, a long term evolution (LTE) system, a 5-th generation (5G) mobile communication system, a 5G new radio (NR) system, or other future new mobile communication systems, etc. It is also to be noted that the sidelinks in the embodiments of the present application may also be referred to as side links or straight-through links.

The network device 101 in the embodiments of the present application is an entity on a network side for transmitting or receiving a signal. For example, the network device 101 may be an evolved nodeB (eNB), a transmission reception point (TRP), a next generation nodeB (gNB) in an NR system, a base station in other future mobile communication systems, or an access node in a wireless fidelity (WiFi) system, etc. The embodiments of the present application do not limit specific technologies and specific device forms used in the network device. The network device provided in the embodiments of the present application may include a central unit (CU) and a distributed unit (DU). The CU may also be referred to as a control unit. Protocol layers of network device such as a base station may be split by the CU-DU structure. Functions of some protocol layers are placed in the CU for centralized control, and functions of remaining or all of the protocol layers are distributed in the DU for centralized control of the DU by the CU.

The terminal device 102 in the embodiments of the present application is an entity on a user side for receiving or transmitting a signal, such as a mobile phone. The terminal device may also be referred to as a terminal, a user equipment (UE), a mobile station (MS), a mobile terminal (MT), etc. The terminal device may be a car with a communication function, a smart car, a mobile phone, a wearable device, a pad, a computer with a wireless transceiver function, a virtual reality (VR) terminal device, an augmented reality (AR) terminal device, a wireless terminal device in industrial control, a wireless terminal device in self-driving, a wireless terminal device in remote medical surgery, a wireless terminal device in smart grid, a wireless terminal device in transportation safety, a wireless terminal device in smart city, a wireless terminal device in smart home, etc. The embodiments of the present application do not limit the specific technologies and the specific device forms used for the terminal device.

In sidelink communication, there are four sidelink transmission modes. Sidelink transmission mode 1 and sidelink transmission mode 2 are used for device-to-device (D2D) communication. Sidelink transmission mode 3 and sidelink transmission mode 4 are used for V2X communication. When sidelink transmission mode 3 is used, resource allocation is scheduled by the network device 101. Specifically, the network device 101 may send resource allocation information to the terminal device 102, and then the terminal device 102 allocates a resource to another terminal device, so that the another terminal device may send information to the network device 101 through the allocated resource. In V2X communication, a terminal device with a better signal or higher reliability may be used as the terminal device 102. A first terminal device mentioned in the embodiments of the present application may refer to the terminal device 102, and a second terminal device may refer to the another terminal device.

It may be understood that the communication system described in the embodiments of the present application is to describe the technical solution in the embodiments of the present application more clearly, but does not constitute a limitation on the technical solution provided in the embodiments of the present application. A person of ordinary skill in the art may understand that, with the evolution of the system architecture and the emergence of new service scenarios, the technical solution provided in the embodiments of the present application are also applicable to similar technical problems.

It is to be noted that the method for determining the fully-coherent transmission codebook using the eight antenna ports for the uplink MIMO transmission according to any one of the embodiments of the present application may be performed alone or in combination with possible implementation methods in other embodiments, or may be performed in combination with any one of the related technologies.

A maximum number of antenna ports supported by existing antenna fully-coherent transmission codewords for uplink MIMO transmission is four, that is, the existing antenna fully-coherent transmission codewords for the uplink MIMO only supports transmission using up to four antenna ports and up to four layers at most. When transmitting antenna ports for the uplink MIMO transmission are enhanced, for example, increased from four antenna ports to eight antenna ports, transmission requirements of the enhanced antenna ports cannot be met.

Embodiments of the present application provide a method and a device for determining a fully-coherent transmission codebook using eight antenna ports for uplink MIMO transmission. High-dimensional fully-coherent transmission codewords for L layers using the eight antenna ports are constructed based on low-dimensional fully-coherent transmission codewords, so that transmission requirements of layer 1 to layer 8 using the eight antenna ports is supported for the uplink MIMO, hence, uplink MIMO technology is further enhanced.

The method and the device for determining the fully-coherent transmission codebook using the eight antenna ports for the uplink MIMO transmission according to the present application are described in detail below with reference to the accompanying drawings.

Referring to FIG. 2, FIG. 2 is a schematic flowchart of a method for determining the fully-coherent transmission codebook using the eight antenna ports for the uplink MIMO transmission according to an embodiment of the present application. As shown in FIG. 2, the method may include, but is not limited to, the following steps.

S201: a first candidate codeword and a second candidate codeword are determined from a candidate codebook of fully-coherent transmission using the four antenna ports for the uplink MIMO transmission.

With the enhancement of transmission requirements and transmission scenarios, uplink transmission may support more antenna ports and uplink transmission layers, that is, the number of antenna ports may be increased from four antenna ports up to eight antenna ports, and accordingly, the number of uplink transmission layers may change from four layers to L layers, for example, a value of L may be any integer from 1 to 8.

L is used to represent a maximum number of transmission layers for the uplink MIMO transmission supported by a terminal device. The value of Z is a positive integer, and 1≤L≤8. Optionally, the number of antenna ports for uplink transmission and the number of uplink transmission layers L may be equal or not equal.

In the present application, a method for determining a candidate codebook using the four antenna ports for fully-coherent transmission is not limited, and may be determined according to an actual situation.

Optionally, an uplink precoding codebook using the four antenna ports for the uplink MIMO transmission specified in the 3GPP communication protocol may be determined, and fully-coherent transmission codewords using the four antenna ports in the uplink precoding codebook may be determined as the candidate codebook of the fully-coherent transmission using the four antenna ports for the uplink MIMO transmission in the embodiments of the present application; or a downlink precoding codebook using the four antenna ports for downlink MIMO transmission specified in the 3GPP communication protocol may be determined, and fully-coherent transmission codewords using the four antenna ports in the downlink precoding codebook may be determined as the candidate codebook of the fully-coherent transmission using the four antenna ports for the uplink MIMO transmission in the embodiments of the present application.

Optionally, candidate codebook of the fully-coherent transmission using the four antenna ports for the uplink MIMO transmission may be preconfigured.

Optionally, a candidate codebook using the four antenna ports for fully-coherent transmission may be determined based on a 4-dimensional orthogonal codebook such as a Kerdock codebook. It is to be noted that the Kerdock codebook is an orthogonal codebook in a communication system design and may be used to construct mutually unbiased basis sequences. The Kerdock codebook is orthogonal. It means that any two column vectors in each Kerdock codeword are mutually orthogonal.

Optionally, in a case where 1≤L≤4, fully-coherent transmission codewords for the L layers using the four antenna ports may be determined from the candidate codebook of the fully-coherent transmission using the four antenna ports for the uplink MIMO transmission, and the fully-coherent transmission codewords for the L layers using the four antenna ports are determined as the first candidate codeword and the second candidate codeword. In other words, in a case where 1≤L≤4, in an embodiment of the present application, L column vectors are arbitrarily selected from the candidate codebook of the fully-coherent transmission using the four antenna ports for the uplink MIMO transmission, and the selected L column vectors may be used as the first candidate codeword and the second candidate codeword. In a case where 1<L≤4, the first candidate codeword and the second candidate codeword are the same.

In some implementations, in a case where 4<L≤8, fully-coherent transmission codewords for ┌L/2┐ layers using the four antenna ports may be determined from the candidate codebook of the fully-coherent transmission using the four antenna ports for the uplink MIMO transmission as the first candidate codeword, and vectors of └L/2┘ layers are selected from the first candidate codeword to generate the second candidate codeword.

In some other implementations, in a case where 4<L≤8, fully-coherent transmission codewords for ┌L/2┐ layers using the four antenna ports may be determined from the candidate codebook of the fully-coherent transmission using the four antenna ports for the uplink MIMO transmission as the first candidate codeword, and fully-coherent transmission codewords for the └L/2┘ layers using the four antenna ports may be determined from the candidate codebook of the fully-coherent transmission using the four antenna ports for the uplink MIMO transmission as the second candidate codeword.

In some other implementations, in a case where 4<L≤8, fully-coherent transmission codewords for four layers using the four antenna ports may be determined from the candidate codebook of the fully-coherent transmission using the four antenna ports for the uplink MIMO transmission, and the fully-coherent transmission codewords for the four layers using the four antenna ports are determined as the first candidate codeword and the second candidate codeword. In other words, the first candidate codeword and the second candidate codeword are the same, and the two candidate codewords are both fully-coherent transmission codewords for the four layers using the four antenna ports.

In some other implementations, in a case where 4<L≤8, fully-coherent transmission codewords for four layers using the four antenna ports may be determined from the candidate codebook of the fully-coherent transmission using the four antenna ports for the uplink MIMO transmission, and the fully-coherent transmission codeword of the four layers using the four antenna ports is determined as the first candidate codeword. Further, fully-coherent transmission codewords for L−4 layers using the four antenna ports is determined as the second candidate codeword. In other words, in a case where 4≤L≤8, in an embodiment of the present application, a first column vector to a fourth column vector are selected from the candidate codebook of the fully-coherent transmission using the four antenna ports for the uplink MIMO transmission, and the selected first column vector to the selected fourth column vector may be used as the first candidate codewords. Further, L−4 column vectors may be arbitrarily selected from the candidate codebook of the fully-coherent transmission using the four antenna ports for the uplink MIMO transmission as the second candidate codewords.

Optionally, the codeword in the present disclosure may refer to a precoding matrix, and the codebook may be a collection of a plurality of codewords/precoding matrices.

S202: a constraint condition that a common phase coefficient needs to meet is determined based on orthogonality of candidate codewords in the candidate codebook, and the common phase coefficient based on the constraint condition is determined.

In some embodiments, the codeword being orthogonal means that the codeword, i.e., the precoding matrix, is an orthogonal matrix. In other words, an inner product of any two column vectors of the precoding matrix is zero.

It is to be noted that each column vector in the codeword corresponds to one transport layer, for example, an i-th column vector corresponds to an i-th transport layer. Any two layers in each candidate codeword in the candidate codebook of the four layers using the four antenna ports are orthogonal each other, and accordingly, any two layers in each codeword in the fully-coherent transmission codebook of the L layers using the eight antenna ports also need to meet features of being orthogonal each other. In an embodiment of the present application, in order to ensure the orthogonality of high-dimensional fully-coherent transmission codewords concatenated by the first candidate codeword and the second candidate codeword, on the premise that both the first candidate codeword and the second candidate codeword meet the orthogonality, the following formula needs to be satisfied when the first candidate codeword and the second candidate codeword are concatenated based on the common phase coefficient:

$${φ}_{1} x , {φ}_{2} y + {φ}_{3} x , {φ}_{4} y = {φ}_{1}^{*} {φ}_{2} {x}^{H} y + {φ}_{3}^{*} {φ}_{4} {x}^{H} y = ( {φ}_{1}^{*} {φ}_{2} + {φ}_{3}^{*} {φ}_{4} ) {\sum }_{n = 1}^{4} {x}_{n}^{*} {y}_{n} = 0 \qquad ( 1 )$$

where φ₁, φ₂, φ₃, and φ₄ are common phase coefficients, x=[a₁ a₂ a₃ a₄]^{T} is any column vector in the first candidate codeword, and y=[b₁ b₂ b₃ b₄]^{T} is any column vector in the second candidate codeword. Since

$${\sum }_{n = 1}^{4} {x}_{n}^{*} {y}_{n}$$

is not always zero, the common phase coefficients need to meet the following formula:

$${φ}_{1}^{*} {φ}_{2} + {φ}_{3}^{*} {φ}_{4} = 0 \qquad ( 2 )$$

In an embodiment of the present application, the formula (2) satisfied by the common phase coefficients is determined as a constraint condition to ensure that any two layers in each the fully-coherent transmission codewords for the L layers using the eight antenna ports are orthogonal each other.

S203: fully-coherent transmission codewords for the L layers using the eight antenna ports for the uplink MIMO transmission are determined by concatenating the first candidate codeword and the second candidate codeword according to the common phase coefficient.

In an embodiment of the present application, the first candidate codeword and the second candidate codeword may be determined from the candidate codebook of the fully-coherent transmission using the four antenna ports, the first candidate codeword and the second candidate codeword are further concatenated based on the common phase coefficient to obtain the fully-coherent transmission codewords for the L layers using the eight antenna ports, and then data transmitted in each layer may be mapped to the eight antenna ports through the determined fully-coherent transmission codewords.

It is to be noted that in an embodiment of the present application, in a case where no energy normalization is performed on a codeword, an energy normalization coefficient corresponding to the codeword may be determined, and energy normalization processing is performed on the codeword based on the energy normalization coefficient. The energy normalization processing for the codeword is also applicable to the following embodiments.

In the technical solution, high-dimensional fully-coherent transmission codewords using the eight antenna ports may be constructed based on low-dimensional fully-coherent transmission codewords, so that transmission requirements of layer 1 to layer 8 using the eight antenna ports is supported for the uplink MIMO, hence, uplink MIMO technology is further enhanced.

In the embodiments of the present application, the first candidate codeword and the second candidate codeword are selected from the candidate codebook of the fully-coherent transmission using the four antenna ports for the uplink MIMO transmission, the constraint condition that the common phase coefficient needs to meet is determined based on the orthogonality of the candidate codewords in the candidate codebook, the common phase coefficient is determined based on the constraint condition, and the first candidate codeword and the second candidate codeword are concatenated according to the common phase coefficient to determine the fully-coherent transmission codewords for the L layers using the eight antenna ports. In the present application, high-dimensional fully-coherent transmission codewords for the L layers using the eight antenna ports are constructed based on low-dimensional fully-coherent transmission codewords, so that transmission requirements of layer 1 to layer 8 using the eight antenna ports is supported for the uplink MIMO, hence, uplink MIMO technology is further enhanced.

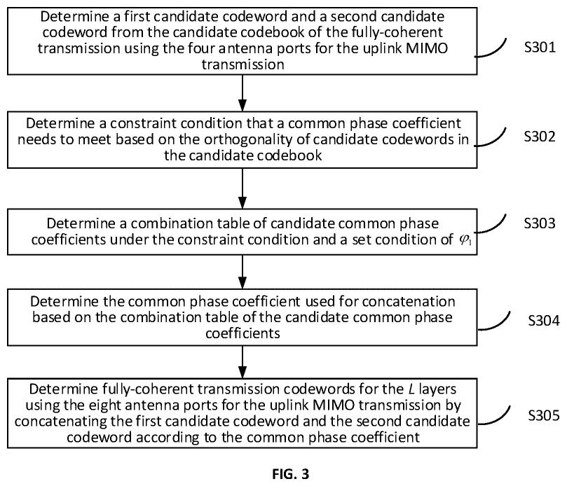

Referring to FIG. 3, FIG. 3 is a schematic flowchart of a method for determining the fully-coherent transmission codebook using the eight antenna ports for the uplink MIMO transmission according to an embodiment of the present application. As shown in FIG. 3, the method may include, but is not limited to, the following steps.

S301: a first candidate codeword and a second candidate codeword is determined from the candidate codebook of the fully-coherent transmission using the four antenna ports for the uplink MIMO transmission.

For a method for determining the candidate codebook of the fully-coherent transmission using the four antenna ports for the uplink MIMO transmission, reference may be made to the description of the relevant contents in the above embodiments, which will not be repeated here.

S302: a constraint condition that a common phase coefficient needs to meet is determined based on the orthogonality of candidate codewords in the candidate codebook.

It is to be noted that each column vector in the codeword corresponds to one transport layer, for example, an i-th column vector corresponds to an i-th transport layer. Any two layers in each candidate codeword in the candidate codebook of the four layers using the four antenna ports are orthogonal each other, and accordingly, any two layers in each codeword in the fully-coherent transmission codebook of the L layers using the eight antenna ports also need to meet features of being orthogonal each other. In an embodiment of the present application, in order to ensure the orthogonality of high-dimensional fully-coherent transmission codewords concatenated by the first candidate codeword and the second candidate codeword, on the premise that both the first candidate codeword and the second candidate codeword meet the orthogonality, the following formula needs to be satisfied when the first candidate codeword and the second candidate codeword are concatenated based on the common phase coefficient:

$$〈 {φ}_{1} x , {φ}_{2} y 〉 + 〈 {φ}_{3} x , {φ}_{4} y 〉 = {φ}_{1}^{*} {φ}_{2} {x}^{H} y + {φ}_{3}^{*} {φ}_{4} {x}^{H} y = ( {φ}_{1}^{*} {φ}_{2} + {φ}_{3}^{*} {φ}_{4} ) {\sum }_{n = 1}^{4} {x}_{n} {y}_{n} = 0 \qquad ( 3 )$$

where φ₁, φ₂, φ₃, and φ₄ are common phase coefficients, x=[a₁ a₂ a₃ a₄]^{T} is any column vector in the first candidate codeword, and y=[b₁ b₂ b₃ b₄]^{T} is any column vector in the second candidate codeword. Since

$${\sum }_{n = 1}^{4} {x}_{n}^{*} {y}_{n}$$

is not always zero, the common phase coefficients need to meet the following formula:

$${φ}_{1}^{*} {φ}_{2} + {φ}_{3}^{*} {φ}_{4} = 0 \qquad ( 4 )$$

In an embodiment of the present application, the formula (4) satisfied by the common phase coefficients is determined as a constraint condition to ensure that any two layers in each the fully-coherent transmission codewords for the L layers using the eight antenna ports are orthogonal each other.

S303: a combination table of candidate common phase coefficients is determined under the constraint condition and a set condition of φ₁.

For example, the first candidate codeword is W_{4,┌L/2┐}, and the second candidate codeword is W_{4,└L/2┘}, where any layer of vector of W_{4,┌L/2┐} is x=[a₁ a₂ a₃ a₄]′, and any layer of vector of the codeword W_{4,└L/2┘} is y=[b₁ b₂ b₃ b₄]. Since any two layers in the codeword W_{4,┌L/2┐} are orthogonal each other, and any two layers in the codeword W_{4,└L/2┘} are orthogonal each other, if it is ensured that any two layers in W_{8,L} are orthogonal each other, the following formula is satisfied:

$$〈 {φ}_{1} x , {φ}_{2} y 〉 + 〈 {φ}_{3} x , {φ}_{4} y 〉 = {φ}_{1}^{*} {φ}_{2} {x}^{H} y + {φ}_{3}^{*} {φ}_{4} {x}^{H} y = ( {φ}_{1}^{*} {φ}_{2} + {φ}_{3}^{*} {φ}_{4} ) {\sum }_{n = 1}^{4} {x}_{n}^{*} {y}_{n} = 0 \qquad ( 5 )$$

$$Since {\sum }_{n = 1}^{4} {x}_{n}^{*} {y}_{n}$$

is not always zero, it may be obtained that

$${φ}_{1}^{*} {φ}_{2} + {φ}_{3}^{*} {φ}_{4} = 0.$$

The common phase coefficient φ₁ is fixed as φ₁=1 (if φ₁≠1, the codeword may be multiplied by

$${φ}_{1}^{*}$$

to convert φ₁ to 1). Therefore, the constraint condition that the common phase coefficient needs to meet is

$${φ}_{2} + {φ}_{3}^{*} {φ}_{4} = 0.$$

In an embodiment of the present application, a combination table of all candidate common phase coefficients that meet the constraint condition is shown in Table 1:

TABLE 1

| | | | | | |
|---|---|---|---|---|---|
| φ₂ = 1 | φ₃ | 1 | −1 | j | −j |
| | φ₄ | −1 | 1 | −j | j |
| φ₂ = −1 | φ₃ | 1 | −1 | j | −j |
| | φ₄ | 1 | −1 | j | −j |
| φ₂ = j | φ₃ | 1 | −1 | j | −j |
| | φ₄ | −j | j | 1 | −1 |
| φ₂ = −j | φ₃ | 1 | −1 | j | −j |
| | φ₄ | j | −j | −1 | 1 |

It may be understood that each element in Table 1 exists independently and these elements are listed as examples in the same table, but it does not mean that all elements in the table must exist simultaneously as shown in the table. A value of each element is independent of a value of any other element in Table 1. Therefore, those skilled in the art may understand that the value of each element in Table 1 is an independent embodiment.

S304: the common phase coefficient used for concatenation is determined based on the combination table of the candidate common phase coefficients.

One combination is selected from the combination table of the candidate common phase coefficients, and the selected combination may be used as a common phase coefficient that may be used for concatenation. For example, it may be that φ₂=1, φ₃=1, and φ₄=−1, where φ₁=1, and it may be satisfied that

$${φ}_{1}^{*} {φ}_{2} + {φ}_{3}^{*} {φ}_{4} = 0.$$

S305: fully-coherent transmission codewords for the L layers using the eight antenna ports for the uplink MIMO transmission are determined by concatenating the first candidate codeword and the second candidate codeword according to the common phase coefficient.

In an embodiment of the present application, the first candidate codeword and the second candidate codeword may be determined from the candidate codebook of the fully-coherent transmission using the four antenna ports, the first candidate codeword and the second candidate codeword are further concatenated based on the common phase coefficient to obtain the fully-coherent transmission codewords for the L layers using the eight antenna ports, and then data transmitted in each layer may be mapped to the eight antenna ports through the determined fully-coherent transmission codeword.

In the embodiments of the present application, the first candidate codeword and the second candidate codeword are selected from the candidate codebook of the fully-coherent transmission using the four antenna ports for the uplink MIMO transmission, the constraint condition that the common phase coefficient needs to meet is determined based on the orthogonality of the candidate codewords in the candidate codebook, the common phase coefficient is determined based on the constraint condition, and the first candidate codeword and the second candidate codeword are concatenated according to the common phase coefficient to determine the fully-coherent transmission codewords for the L layers using the eight antenna ports. In the present application, high-dimensional fully-coherent transmission codewords for the L layers using the eight antenna ports are constructed based on low-dimensional fully-coherent transmission codewords, so that transmission requirements of layer 1 to layer 8 using the eight antenna ports is supported for the uplink MIMO, hence, uplink MIMO technology is further enhanced.

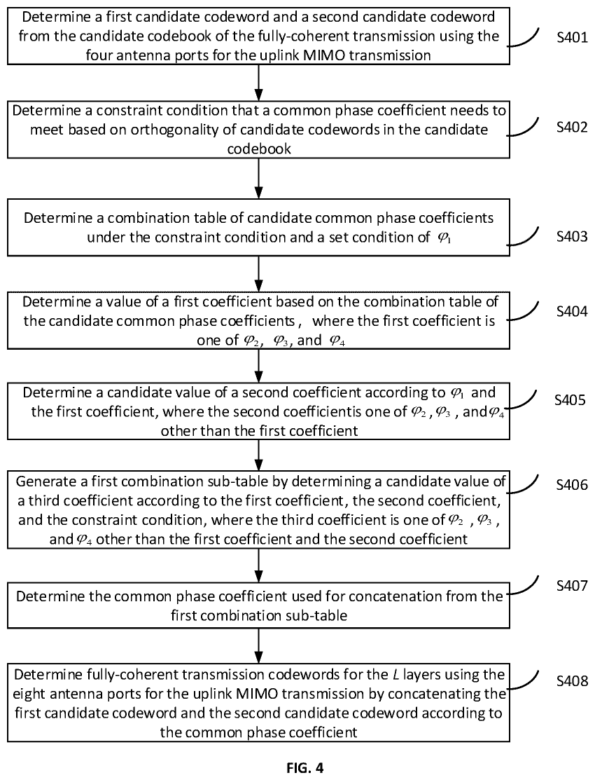

Referring to FIG. 4, FIG. 4 is a schematic flowchart of a method for determining the fully-coherent transmission codebook using the eight antenna ports for the uplink MIMO transmission according to an embodiment of the present application. As shown in FIG. 4, the method may include, but is not limited to, the following steps.

S401: a first candidate codeword and a second candidate codeword is determined from the candidate codebook of the fully-coherent transmission using the four antenna ports for the uplink MIMO transmission.

S402: a constraint condition that a common phase coefficient needs to meet is determined based on orthogonality of candidate codewords in the candidate codebook.

S403: a combination table of candidate common phase coefficients is determined under the constraint condition and a set condition of φ₁.

For specific introduction of steps S401 to S403, reference may be made to the description of the relevant contents in the above embodiments, which will not be repeated here.

S404: a value of a first coefficient is determined based on the combination table of the candidate common phase coefficients, where the first coefficient is one of φ₂, φ₃, and φ₄. The value of the first coefficient may occupy two bits for indication.

S405: a candidate value of a second coefficient is determined according to φ₁ and the first coefficient, where the second coefficient is one of φ₂, φ₃, and φ₄ other than the first coefficient.

S406: a first combination sub-table is generated by determining a candidate value of a third coefficient according to the first coefficient, the second coefficient, and the constraint condition, where the third coefficient is one of φ₂, φ₃, and φ₄ other than the first coefficient and the second coefficient.

Optionally, the first coefficient may be φ₂, φ₃, or φ₄.

Taking the first coefficient being φ₂, the second coefficient being φ₃, and the third coefficient being φ₄ as an example, the value of φ₂ may be determined as 1 based on the combination table 1 of the candidate common phase coefficients. Further, candidate values of φ₃ may be determined as {1, −1, j, −j} based on the first coefficient. After the candidate values of the second coefficient are determined, candidate values of φ₄ may be determined as {−1, 1, −j, j} based on φ₄=−φ₂φ₃ and the constraint condition, to obtain a first combination sub-table of candidate common phase coefficients, as shown in Table 2:

TABLE 2

| | | | | |
|---|---|---|---|---|
| φ₃ | 1 | −1 | j | −j |
| φ₄ | −1 | 1 | −j | j |

It may be understood that each element in Table 2 exists independently and these elements are listed as examples in the same table, but it does not mean that all elements in the table must exist simultaneously as shown in the table. A value of each element is independent of a value of any other element in Table 2 and Table 3. Therefore, those skilled in the art may understand that the value of each element in Table 2 is an independent embodiment.

Taking the first coefficient being φ₃, the second coefficient being φ₂, and the third coefficient being φ₄ as an example, the value of φ₃ may be determined as 1 based on the combination table 1 of the candidate common phase coefficients. Further, candidate values of φ₂ may be determined as {1,−1, j,−j} based on the first coefficient. After the candidate values of the second coefficient are determined, candidate values of φ₄ may be determined as {−1, 1,−j, j} based on φ₄=−φ₂₉₃ and the constraint condition, to obtain a first combination sub-table of candidate common phase coefficients, as shown in Table 3:

TABLE 3

| | | | | |
|---|---|---|---|---|
| φ₂ | 1 | −1 | j | −j |
| φ₄ | −1 | 1 | −j | j |

It may be understood that each element in Table 3 exists independently and these elements are listed as examples in the same table, but it does not mean that all elements in the table must exist simultaneously as shown in the table. A value of each element is independent of a value of any other element in Table 3. Therefore, those skilled in the art may understand that the value of each element in Table 3 is an independent embodiment.

It is to be noted that in an embodiment of the present application, φ₂=1 or φ₃=1 determined based on the combination table of candidate common phase coefficients is only an example, and the value of φ₂ or φ₃ may also be other cases, for example, φ₂=j. It may be understood that candidate common phase coefficients obtained based on different values of φ₂ or φ₃ correspond to different first combination sub-tables.

In an embodiment of the present application, since there are four candidate values of φ₂ or φ₃, an actual value of φ₂ or φ₃ may be indicated by two bits, and then an actual value of φ₄ may be determined in combination with an expression of φ₄ based on the actual value of φ₂ or φ₃.

S407: the common phase coefficient used for concatenation is determined from the first combination sub-table.

One combination is selected from the first composite sub-table of the candidate common phase coefficients, and the selected combination may be used as the common phase coefficient that may be used for concatenation. For example, it may be that φ₂=1, φ₃=1, and φ₄=−1, where φ₁=1, and it may be satisfied that

$${φ}_{1}^{*} {φ}_{2} + {φ}_{3}^{*} {φ}_{4} = 0.$$

S408: fully-coherent transmission codewords for the L layers using the eight antenna ports for the uplink MIMO transmission are determined by concatenating the first candidate codeword and the second candidate codeword according to the common phase coefficient.

For specific introduction of step S408, reference may be made to the description of the relevant contents in the above embodiments, which will not be repeated here.

In the embodiments of the present application, the first candidate codeword and the second candidate codeword are selected from the candidate codebook of the fully-coherent transmission using the four antenna ports for the uplink MIMO transmission, the constraint condition that the common phase coefficient needs to meet is determined based on the orthogonality of the candidate codewords in the candidate codebook, the common phase coefficient is determined based on the constraint condition, and the first candidate codeword and the second candidate codeword are concatenated according to the common phase coefficient to determine the fully-coherent transmission codewords for the L layers using the eight antenna ports. In the present application, high-dimensional fully-coherent transmission codewords for the L layers using the eight antenna ports are constructed based on low-dimensional fully-coherent transmission codewords, so that transmission requirements of layer 1 to layer 8 using the eight antenna ports is supported for the uplink MIMO, hence, uplink MIMO technology is further enhanced.

Referring to FIG. 5, FIG. 5 is a schematic flowchart of a method for determining the fully-coherent transmission codebook using the eight antenna ports for the uplink MIMO transmission according to an embodiment of the present application. As shown in FIG. 5, the method may include, but is not limited to, the following steps.

S501: a first candidate codeword and a second candidate codeword is determined from the candidate codebook of the fully-coherent transmission using the four antenna ports for the uplink MIMO transmission.

S502: a constraint condition that a common phase coefficient needs to meet is determined based on orthogonality of candidate codewords in the candidate codebook.

S503: a combination table of candidate common phase coefficients is determined under the constraint condition and a set condition of φ₁.

For specific introduction of steps S501 to S503, reference may be made to the description of the relevant contents in the above embodiments, which will not be repeated here.

S504: a value range of two coefficients are determined based on the combination table, where the two coefficients are two of φ₂, φ₃, and φ₄, and the value range includes two candidate values, and values of the two coefficients are determined based on the two candidate values. The values of the two coefficients each may occupy one bit for indication.

S505: a second combination sub-table is generated by determining a value of a remaining coefficient based on the values of the two coefficients and the constraint condition, where the remaining coefficient is the remaining one of φ₂, φ₃, and φ₄.

In an embodiment of the present application, the two coefficients may be φ₂ and φ₃, φ₃ and φ₄, or φ₂ and φ₄.

In some implementations, the value range of two coefficients in φ₂, φ₃, and φ₄ may be determined based on the combination table, and the values of the two coefficients may be determined within limitation of the value range. In an embodiment of the present application, the value range of each of the two coefficients includes two candidate values, and the values of the two coefficients may be determined based on the two candidate values.

Taking the two coefficients being φ₂ and φ₃ as an example, based on the combination table 1 of the candidate common phase coefficients, the value of φ₂ may be determined as {1, −1}, that is, φ₂∈{1, −1}, and accordingly, the candidate values of φ₂ are 1 and −1; based on the combination table 1 of the candidate common phase coefficients, the value of φ₃ may be determined as {1, −1}, that is, φ₃∈{1, −1}, and accordingly, the candidate values of φ₃ are 1 and −1.

After the values of the two coefficients are determined, the candidate value of φ₄ may be determined as {−1,1} through φ₄=φ₂φ₃ based on the values of the two coefficients and the constraint condition, to obtain a second combination sub-table of candidate common phase coefficients, as shown in Table 4:

TABLE 4

| | | | |
|---|---|---|---|
| φ₂ = 1 | φ₃ | 1 | −1 |
| | φ₄ | −1 | 1 |
| φ₂ = −1 | φ₃ | 1 | −1 |
| | φ₄ | 1 | −1 |

It may be understood that each element in Table 4 exists independently and these elements are listed as examples in the same table, but it does not mean that all elements in the table must exist simultaneously as shown in the table. A value of each element is independent of a value of any other element in Table 4. Therefore, those skilled in the art may understand that the value of each element in Table 4 is an independent embodiment.

It is to be noted that in an embodiment of the present application, the determined value range of φ₂ and value range of φ₃ based on the combination table 1 of the candidate common phase coefficients are merely examples, the value ranges of φ₂ and φ₃ may also be other cases, for example, φ₂∈{j,−j} or φ₃∈{j,−j}. It may be understood that different second combination sub-tables corresponding to the candidate common phase coefficients may be obtained according to different value ranges of φ₂ and φ₃.

In an embodiment of the present application, since there are two candidate values of φ₂ and φ₃, the actual values of φ₂ and φ₃ may be indicated by one bit, and then based on the actual values of φ₂ and φ₃, the actual value of φ₄ may be determined in combination with an expression of 94.

S506: the common phase coefficient for concatenation is determined from the second combination sub-table.

One combination is selected from the second combination sub-table of the candidate common phase coefficients, and the selected combination may be used as the common phase coefficient that may be used for concatenation. For example, it may be that φ₂=1, φ₃=1, and φ₄=−1, where φ₁=1, and it may be satisfied that

$${φ}_{1}^{*} {φ}_{2} + {φ}_{3}^{*} {φ}_{4} = 0.$$

S507: fully-coherent transmission codewords for the L layers using the eight antenna ports for the uplink MIMO transmission is determined by concatenating the first candidate codeword and the second candidate codeword according to the common phase coefficient.

For specific introduction of step S507, reference may be made to the description of the relevant contents in the above embodiments, which will not be repeated here.

In the embodiments of the present application, the first candidate codeword and the second candidate codeword are selected from the candidate codebook of the fully-coherent transmission using the four antenna ports for the uplink MIMO transmission, the constraint condition that the common phase coefficient needs to meet is determined based on the orthogonality of the candidate codewords in the candidate codebook, the common phase coefficient is determined based on the constraint condition, and the first candidate codeword and the second candidate codeword are concatenated according to the common phase coefficient to determine the fully-coherent transmission codewords for the L layers using the eight antenna ports. In the present application, high-dimensional fully-coherent transmission codewords for the L layers using the eight antenna ports are constructed based on low-dimensional fully-coherent transmission codewords, so that transmission requirements of layer 1 to layer 8 using the eight antenna ports is supported for the uplink MIMO, hence, uplink MIMO technology is further enhanced.

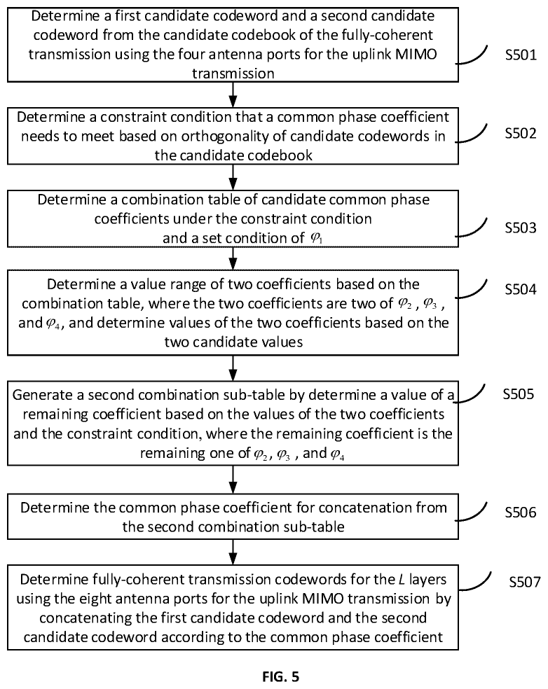

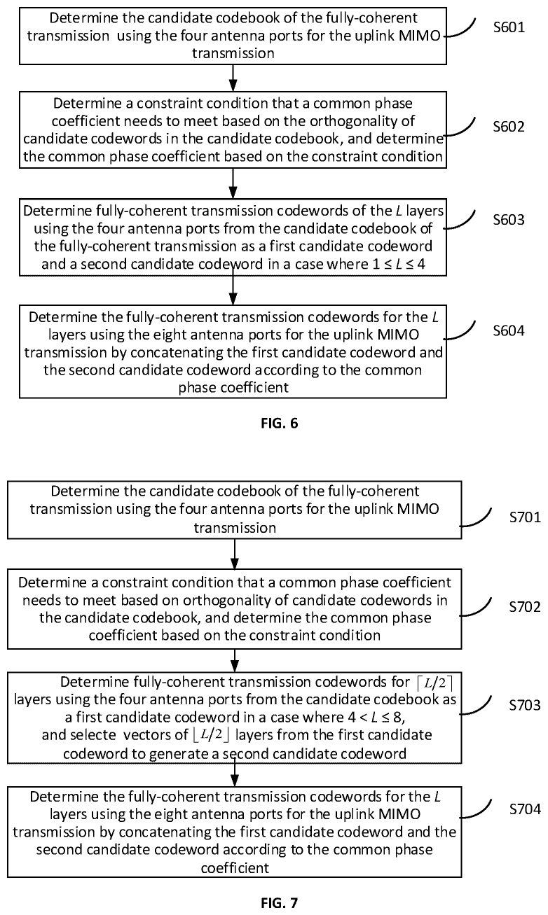

Referring to FIG. 6, FIG. 6 is a schematic flowchart of a method for determining the fully-coherent transmission codebook using the eight antenna ports for the uplink MIMO transmission according to an embodiment of the present application. As shown in FIG. 6, the method may include, but is not limited to, the following steps.

S601: the candidate codebook of the fully-coherent transmission is determined using the four antenna ports for the uplink MIMO transmission.

For a method for determining the candidate codebook of the fully-coherent transmission, reference may be made to the description of the relevant contents in the above embodiments, which will not be repeated here.

S602: a constraint condition that a common phase coefficient needs to meet is determined based on the orthogonality of candidate codewords in the candidate codebook, and the common phase coefficient based on the constraint condition is determined.

For specific introduction of step S602, reference may be made to the description of the relevant contents in the above embodiments, which will not be repeated here.

S603: in a case where 1≤L≤4, fully-coherent transmission codewords for the L layers using the four antenna ports from the candidate codebook of the fully-coherent transmission is determined as a first candidate codeword and a second candidate codeword.

In a case where 1≤L≤4, the first candidate codeword and the second candidate codeword are the same.

Optionally, in a case where 1≤L≤4, fully-coherent transmission codewords for the L layers using the four antenna ports may be arbitrarily selected from the candidate codebook of the fully-coherent transmission using the four antenna ports for the uplink MIMO transmission, and the selected fully-coherent transmission codeword of the L layers using the four antenna ports is determined as a first candidate codeword W_{4,L}. In an embodiment of the present application, the second candidate codeword is also W_{4,L}.

S604: the fully-coherent transmission codewords for the L layers using the eight antenna ports for the uplink MIMO transmission are determined by concatenating the first candidate codeword and the second candidate codeword according to the common phase coefficient.

A first common phase coefficient matrix is determined according to the common phase coefficient.

φ₁ and φ₃ are common phase coefficients, and the first common phase coefficient matrix may be determined as

$$Φ = [ \begin{matrix}{φ}_{1} \\ {φ}_{3}\end{matrix} ] .$$

Further, a first concatenated codeword is generated by concatenating the first candidate codeword and the second candidate codeword in a row dimension.

Further, the fully-coherent transmission codewords for the L layers using the eight antenna ports for the uplink MIMO transmission is generated by performing Hadamard product operation on the first common phase coefficient matrix and the first concatenated codeword.

In an embodiment of the present application, the first candidate codeword and the second candidate codeword are concatenated in the row dimension to generate a first concatenated codeword [W_{4, L} W_{4, L}]^{T}, that is, fully-coherent transmission codewords for the L layers of two four antenna ports are concatenated in the row dimension to generate the first concatenated codeword. Further, Hadamard product operation is performed on the first common phase coefficient matrix and the first concatenated codeword to generate the fully-coherent transmission codewords for the L layers using the eight antenna ports for the uplink MIMO transmission.

In an embodiment of the present application, W_{4,L} is concatenated based on the first common phase coefficient matrix to obtain the first concatenated codeword, and the obtained fully-coherent transmission codewords for the L layers using the eight antenna ports may be

$${W}_{8 , L} = [ \begin{matrix}{φ}_{1} {W}_{4 , L} \\ {φ}_{3} {W}_{4 , L}\end{matrix} ] .$$

For example, if L=3, and the fully-coherent transmission codewords for three layers using the four antenna ports is the first candidate codeword:

$${W}_{4 , 3} = [ \begin{matrix}1 & 1 & 1 \\ 1 & - 1 & 1 \\ 1 & 1 & - 1 \\ 1 & - 1 & - 1\end{matrix} ] and$$

$$Φ = [ \begin{matrix}1 \\ j\end{matrix} ] ,$$

the fully-coherent transmission codeword of three layers using the eight antenna ports is:

$${W}_{8 , 3} = [ \begin{matrix}{W}_{4 , 3} \\ {jW}_{4 , 3}\end{matrix} ] = [ \begin{matrix}1 & 1 & 1 \\ 1 & - 1 & 1 \\ 1 & 1 & - 1 \\ 1 & - 1 & - 1 \\ j & j & j \\ j & - j & j \\ j & j & - j \\ j & - j & - j\end{matrix} ] .$$

In the present application, high-dimensional fully-coherent transmission codewords for the L layers using the eight antenna ports are constructed based on low-dimensional fully-coherent transmission codewords, so that transmission requirements of layer 1 to layer 8 using the eight antenna ports is supported for the uplink MIMO, hence, uplink MIMO technology is further enhanced.

Referring to FIG. 7, FIG. 7 is a schematic flowchart of a method for determining the fully-coherent transmission codebook using the eight antenna ports for the uplink MIMO transmission according to an embodiment of the present application. As shown in FIG. 7, the method may include, but is not limited to, the following steps.

S701: the candidate codebook of the fully-coherent transmission using the four antenna ports for the uplink MIMO transmission is determined.

For the method for determining the candidate codebook of the fully-coherent transmission, reference may be made to the description of the relevant contents in the above embodiments, which will not be repeated here.

S702: a constraint condition that a common phase coefficient needs to meet is determined based on orthogonality of candidate codewords in the candidate codebook, and the common phase coefficient based on the constraint condition is determined.

For specific introduction of step S702, reference may be made to the description of the relevant contents in the above embodiments, which will not be repeated here.

S703: in a case where 4<L≤8, fully-coherent transmission codewords for ┌L/2┐ layers using the four antenna ports are determined from the candidate codebook as a first candidate codeword, and vectors of └L/2┘ layers is selected from the first candidate codeword to generate a second candidate codeword.

Optionally, fully-coherent transmission codeword W_{4,┌L/2┐} of any ┌L/2┐ layers using the four antenna ports is determined as the first candidate codeword, and any └L/2┘ layers of W_{4,┌L/2┐} is determined as the second candidate codeword W_{4,┌L/2┐}′. For example, the previous vectors of └L/2┘ layers may be selected to generate the second candidate codeword.

S704: the fully-coherent transmission codewords for the L layers using the eight antenna ports for the uplink MIMO transmission are determined by concatenating the first candidate codeword and the second candidate codeword according to the common phase coefficient.

A second common phase coefficient matrix is determined according to common phase coefficients. φ₁, φ₂, φ₃, and φ₄ are the common phase coefficients, and a second common phase coefficient matrix may be determined as:

$$Φ = [ \begin{matrix}{φ}_{1} & {φ}_{2} \\ {φ}_{3} & {φ}_{4}\end{matrix} ] .$$

Further, in an embodiment of the present application, after the first candidate codeword and the second candidate codeword are determined, a second concatenated codeword may be obtained by concatenating two first candidate codewords in the row dimension, and a third concatenated codeword may be obtained by concatenating two second candidate codewords in the row dimension. Further, a fourth concatenated codeword may be obtained by concatenating the second concatenated codeword and the third concatenated codeword in a column dimension. In an embodiment of the present application, the fully-coherent transmission codeword of the L layers using the eight antenna ports may be obtained by performing Hadamard product operation on the second common phase coefficient matrix and the fourth concatenated codeword.

Fully-coherent transmission codewords W_{8,L} of L layers using 8Tx may be

$${W}_{8 , L} = [ \begin{matrix}{φ}_{1} {W}_{4 , ⌈ L / 2 ⌉} & {φ}_{2} {W}_{4 , ⌈ L / 2 ⌉}^{′} \\ {φ}_{3} {W}_{4 , ⌈ L / 2 ⌉} & {φ}_{4} {W}_{4 , ⌈ L / 2 ⌉}^{′}\end{matrix} ] .$$

For example, L=7, the fully-coherent transmission codewords for four layers using the four antenna ports are the first candidate codewords:

$${W}_{4 , 4} = [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ] ,$$

and the second candidate codewords are

$${W}_{4 , 4}^{′} = [ \begin{matrix}1 & 1 & 1 \\ 1 & - 1 & 1 \\ 1 & 1 & - 1 \\ 1 & - 1 & - 1\end{matrix} ] , where {W}_{4 , 4}^{′}$$

includes first, second, and third columns of W_{4,4}.

$$Φ = [ \begin{matrix}1 & 1 \\ j & - j\end{matrix} ] ,$$

and the fully-coherent transmission codewords for seven layers using the eight antenna ports are:

$${W}_{8 , 7} = [ \begin{matrix}{W}_{4 , 4} & {W}_{4 , 4}^{′} \\ {jW}_{4 , 4} & - {jW}_{4 , 4}^{′}\end{matrix} ] .$$

In the present application, high-dimensional fully-coherent transmission codewords for the L layers using the eight antenna ports are constructed based on low-dimensional fully-coherent transmission codewords, so that transmission requirements of layer 1 to layer 8 using the eight antenna ports is supported for the uplink MIMO, hence, uplink MIMO technology is further enhanced.

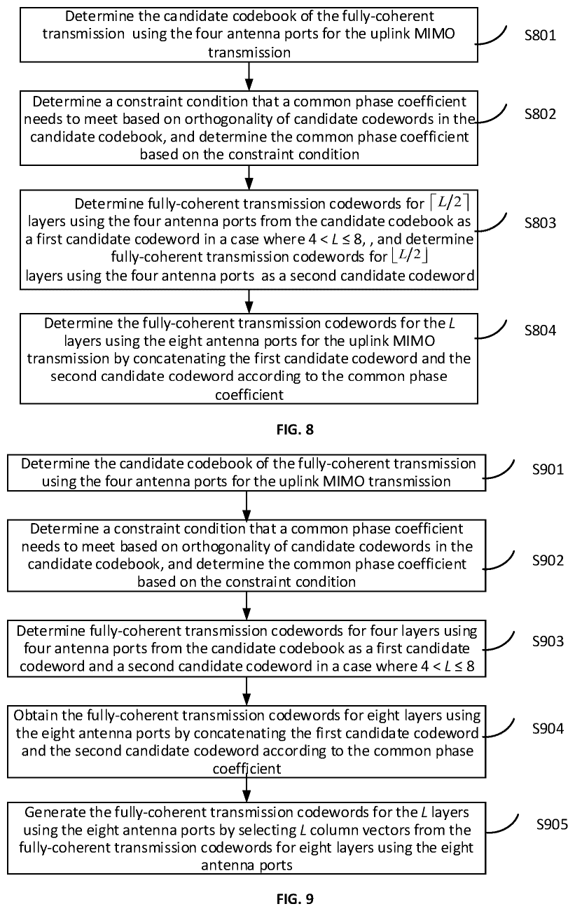

Referring to FIG. 8, FIG. 8 is a schematic flowchart of a method for determining the fully-coherent transmission codebook using the eight antenna ports for the uplink MIMO transmission according to an embodiment of the present application. As shown in FIG. 8, the method may include, but is not limited to, the following steps.

S801: the candidate codebook of the fully-coherent transmission using the four antenna ports for the uplink MIMO transmission is determined.

For the method for determining the candidate codebook of the fully-coherent transmission, reference may be made to the description of the relevant contents in the above embodiments, which will not be repeated here.

S802: a constraint condition that a common phase coefficient needs to meet is determined based on orthogonality of candidate codewords in the candidate codebook, and the common phase coefficient is determined based on the constraint condition.

For specific introduction of step S802, reference may be made to the description of the relevant contents in the above embodiments, which will not be repeated here.

S803: In a case where 4<L≤8, fully-coherent transmission codewords for ┌L/2┐ layers using the four antenna ports from the candidate codebook are determined as a first candidate codeword, and fully-coherent transmission codewords for ┌L/2┐ layers using the four antenna ports are determined as a second candidate codeword.

Optionally, the fully-coherent transmission codewords for any └L/2┘ layers using the four antenna ports is selected as the first candidate codeword W_{4,┌L/2┐}, and the fully-coherent transmission codewords for any └L/2┘ layers using the four antenna ports is selected as the second candidate codeword W_{4,┌L/2┐}.

S804: the fully-coherent transmission codewords for the L layers using the eight antenna ports for the uplink MIMO transmission are determined by concatenating the first candidate codeword and the second candidate codeword according to the common phase coefficient.

A second common phase coefficient matrix is determined according to common phase coefficients. φ₁, φ₂, φ₃, and φ₄ are the common phase coefficients, and a second common phase coefficient matrix may be determined as:

$$Φ = [ \begin{matrix}{φ}_{1} & {φ}_{2} \\ {φ}_{3} & {φ}_{4}\end{matrix} ] .$$

In an embodiment of the present application, after the first candidate codeword and the second candidate codeword are determined, for a process of concatenating the first candidate codeword and the second candidate codeword based on the second common phase coefficient matrix, reference may be made to the description of the relevant contents in the above embodiments, which will not be repeated here.

The fully-coherent transmission codewords for the L layers using the eight antenna ports may be

$${W}_{8 , L} = [ \begin{matrix}{φ}_{1} {W}_{4 , ⌈ L / 2 ⌉} & {φ}_{2} {W}_{4 , ⌊ L / 2 ⌋} \\ {φ}_{3} {W}_{4 , ⌈ L / 2 ⌉} & {φ}_{4} {W}_{4 , ⌊ L / 2 ⌋}\end{matrix} ] .$$

For example, L=7, the fully-coherent transmission codewords for four layers using the four antenna ports are selected as the first candidate codewords:

$${W}_{4 , 4} = [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$$

and the fully-coherent transmission codewords for three layers using the four antenna ports are selected as the second candidate codewords:

$${W}_{4 , 3} = [ \begin{matrix}1 & 1 & 1 \\ 1 & - 1 & 1 \\ 1 & 1 & - 1 \\ 1 & - 1 & - 1\end{matrix} ] .$$

$$Φ = [ \begin{matrix}1 & 1 \\ j & - j\end{matrix} ] ,$$

and the fully-coherent transmission codewords for seven layers using the eight antenna ports are

$${W}_{8 , 7} = [ \begin{matrix}{W}_{4 , 4} & {W}_{4 , 3} \\ {jW}_{4 , 4} & - {jW}_{4 , 3}\end{matrix} ] .$$

In an embodiment of the present application, fully-coherent transmission codewords using high-dimensional 8Tx antenna may be constructed based on fully-coherent transmission codewords using low-dimensional antenna, so that uplink MIMO supports the transmission requirements of layer 1 to layer 8 using 8Tx, thereby further enhancing the uplink MIMO technology.

Referring to FIG. 9, FIG. 9 is a schematic flowchart of a method for determining the fully-coherent transmission codebook using the eight antenna ports for the uplink MIMO transmission according to an embodiment of the present application. As shown in FIG. 9, the method may include, but is not limited to, the following steps.

S901: the candidate codebook of the fully-coherent transmission using the four antenna ports for the uplink MIMO transmission is determined.

For the method for determining the candidate codebook of the fully-coherent transmission, reference may be made to the description of the relevant contents in the above embodiments, which will not be repeated here.

S902: a constraint condition that a common phase coefficient needs to meet is determined based on orthogonality of candidate codewords in the candidate codebook, and the common phase coefficient is determined based on the constraint condition.

For specific introduction of step S902, reference may be made to the description of the relevant contents in the above embodiments, which will not be repeated here.

S903: In a case where 4<L≤8, fully-coherent transmission codewords for four layers using the four antenna ports are determined from the candidate codebook as a first candidate codeword and a second candidate codeword.

S904: the fully-coherent transmission codewords for eight layers using the eight antenna ports are obtained by concatenating the first candidate codeword and the second candidate codeword according to the common phase coefficient.

S905: the fully-coherent transmission codewords for the L layers using the eight antenna ports are generated by selecting L column vectors from the fully-coherent transmission codewords for eight layers using the eight antenna ports.

Optionally, the fully-coherent transmission codewords for any four layers using 4Tx is determined as the first candidate codeword W_{4,4}, where the second candidate codeword may also be W_{4,4}.

φ₁, φ₂, φ₃, and φ₄ are the common phase coefficients, and a second common phase coefficient matrix may be determined as:

$$Φ = [ \begin{matrix}{φ}_{1} & {φ}_{2} \\ {φ}_{3} & {φ}_{4}\end{matrix} ] .$$

In an embodiment of the present application, after the first candidate codeword and the second candidate codeword are determined, for a process of concatenating the first candidate codeword and the second candidate codeword based on the second common phase coefficient matrix, reference may be made to the description of the relevant contents in the above embodiments, which will not be repeated here.

That is, the fully-coherent transmission codewords W_{8,L} of the L layers using the eight antenna ports may be a matrix composed of any L layers of W_{8,8}, where

$${W}_{8 , 8} = [ \begin{matrix}{φ}_{1} {W}_{4 , 4} & {φ}_{2} {W}_{4 , 4} \\ {φ}_{3} {W}_{4 , 4} & {φ}_{4} {W}_{4 , 4}\end{matrix} ] ,$$

and the fully-coherent transmission codewords for the L layers using the eight antenna ports are composed of any L layers selected from W_{8,8}.

For example, L=7, the first candidate codewords for four layers using the four antenna ports for fully-coherent transmission are

$${W}_{4 , 4} = [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ] ;$$

and the second candidate codeword is W_{4,4};
where

$$Φ = [ \begin{matrix}1 & 1 \\ j & - j\end{matrix} ] ,$$

the fully-coherent transmission codewords for seven layers using the eight antenna ports are a matrix composed of any seven column vectors, for example, first to the seven column vectors in

$${W}_{8 , 8} = [ \begin{matrix}{W}_{4 , 4} & {W}_{4 , 4} \\ j {W}_{4 , 4} & - {jW}_{4 , 4}\end{matrix} ] .$$

In the present application, high-dimensional fully-coherent transmission codewords for the L layers using the eight antenna ports are constructed based on low-dimensional fully-coherent transmission codewords, so that transmission requirements of layer 1 to layer 8 using the eight antenna ports is supported for the uplink MIMO, hence, uplink MIMO technology is further enhanced.

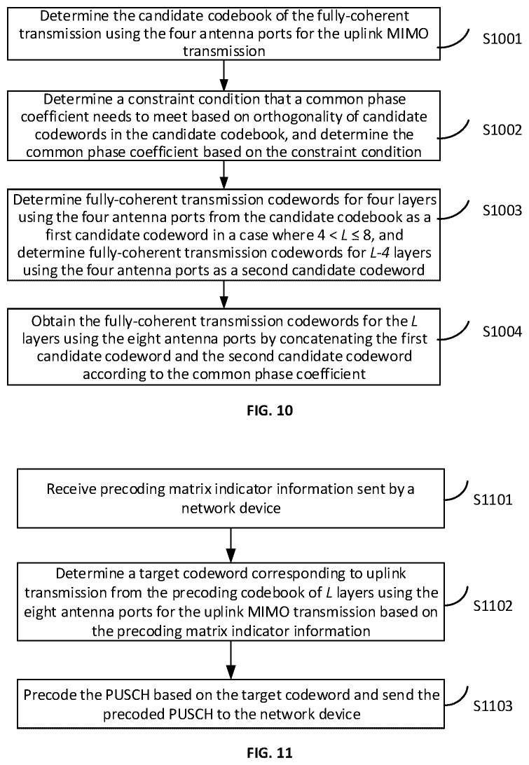

Referring to FIG. 10, FIG. 10 is a schematic flowchart of a method for determining the fully-coherent transmission codebook using the eight antenna ports for the uplink MIMO transmission according to an embodiment of the present application. As shown in FIG. 10, the method may include, but is not limited to, the following steps.

S1001: the candidate codebook of the fully-coherent transmission using the four antenna ports for the uplink MIMO transmission is determined.

For the method for determining the candidate codebook of the fully-coherent transmission, reference may be made to the description of the relevant contents in the above embodiments, which will not be repeated here.

S1002: a constraint condition that a common phase coefficient needs to meet is determined based on orthogonality of candidate codewords in the candidate codebook, and the common phase coefficient is determined based on the constraint condition.

For specific introduction of step S1002, reference may be made to the description of the relevant contents in the above embodiments, which will not be repeated here.

S1003: In a case where 4<L≤8, fully-coherent transmission codewords for four layers using the four antenna ports from the candidate codebook are determined as a first candidate codeword, and fully-coherent transmission codewords for L−4 layers using the four antenna ports are determined as a second candidate codeword.

Optionally, fully-coherent transmission codeword of any four layers using the four antenna ports is determined from the candidate codebook of the fully-coherent transmission using the four antenna ports for the uplink MIMO transmission as the first candidate codeword W_{4,4}; and further, fully-coherent transmission codeword of any L−4 layers using the four antenna ports is determined as the second candidate codeword W_{4,L-4}.

S1004: the fully-coherent transmission codewords for the L layers using the eight antenna ports are obtained by concatenating the first candidate codeword and the second candidate codeword according to the common phase coefficient.

A second common phase coefficient matrix is determined based on common phase coefficients. φ₁, φ₂, φ₃, and φ₄ are the common phase coefficients, and a second common phase coefficient matrix may be determined as:

$$Φ = [ \begin{matrix}{φ}_{1} & {φ}_{2} \\ {φ}_{3} & {φ}_{4}\end{matrix} ] .$$

In an embodiment of the present application, after the first candidate codeword and the second candidate codeword are determined, the first candidate codeword and the second candidate codeword may be concatenated in a row dimension to obtain a second concatenated codeword [W_{4,4} W_{4,4}]^{T}, and two second candidate codewords are concatenated in the row dimension to obtain a third concatenated codeword [W_{4, L-4} W_{4, L-4}]^{T}. Further, the second concatenated codeword and the third concatenated codeword are concatenated in a column dimension to obtain a fourth concatenated codeword

$$[ \begin{matrix}{W}_{4 , 4} & {W}_{4 , L - 4} \\ {W}_{4 , 4} & {W}_{4 , L - 4}^{′}\end{matrix} ] .$$

In an embodiment of the present application, Hadamard product operation is performed on the second common phase coefficient matrix and the fourth concatenated codeword to generate the fully-coherent transmission codewords for the L layers using the eight antenna ports

$${W}_{8 , L} = [ \begin{matrix}{φ}_{1} {W}_{4 , 4} & {φ}_{2} {W}_{4 , L - 4} \\ {φ}_{3} {W}_{4 , 4} & {φ}_{4} {W}_{4 , L - 4}\end{matrix} ] .$$

For example, if L=5, the fully-coherent transmission codewords for four layers using the four antenna ports are

$${W}_{4 , 4} = [ \begin{matrix}1 & 1 & 1 & 1 \\ 1 & - 1 & 1 & - 1 \\ 1 & 1 & - 1 & - 1 \\ 1 & 1 & 1 & 1\end{matrix} ] ,$$

the fully-coherent transmission codewords for one layer using the four antenna ports are

$${W}_{4 , 1} = [ \begin{matrix}1 \\ 1 \\ 1 \\ 1\end{matrix} ] ,$$

and the second common phase coefficient matrix is

$$Φ = [ \begin{matrix}1 & 1 \\ j & - j\end{matrix} ] ,$$

the fully-coherent transmission codewords for five layers using the eight antenna ports are

$${W}_{8 , 5} = [ \begin{matrix}{W}_{4 , 4} & {W}_{4 , 1} \\ {jW}_{4 , 4} & - {jW}_{4 , 1}\end{matrix} ] .$$

It is to be noted that in an embodiment of the present application, two fully-coherent transmission codewords for four layers using the four antenna ports may be determined as first candidate codeword. Two fully-coherent transmission codewords for L−4 layers using the four antenna ports may be determined as second candidate codeword.

In some implementations, two identical fully-coherent transmission codewords for four layers using the four antenna ports may be selected as the first candidate codeword, W_{4,4} and W_{4,4} may be concatenated in the row dimension to obtain [W_{4,4} W_{4,4}]^{T}, where [W_{4,4} W_{4,4}]^{T} is the second concatenated codeword. Further, two identical fully-coherent transmission codewords for L−4 layers using the four antenna ports are selected as the second candidate codeword, and W_{4,L-4} and W_{4,L-4} may be concatenated in the row dimension to obtain [W_{4,L-4} W_{4,6-4}]^{T}, where [W_{4,L-4} W_{4,L-4}] is the third concatenated codeword.

The fully-coherent transmission codewords for the L layers using the eight antenna ports are

$${W}_{8 , L} = [ \begin{matrix}{φ}_{1} {W}_{4 , 4} & {φ}_{2} {W}_{4 , L - 4} \\ {φ}_{3} {W}_{4 , 4} & {φ}_{4} {W}_{4 , L - 4}\end{matrix} ] .$$

For example, the fully-coherent transmission codewords for six layers using the eight antenna ports may be composed of two identical fully-coherent transmission codewords for four layers using the four antenna ports and two identical fully-coherent transmission codewords for two layers using the four antenna ports, that is,

$${W}_{8 , 6} = [ \begin{matrix}{φ}_{1} {W}_{4 , 4} & {φ}_{2} {W}_{4 , 2} \\ {φ}_{3} {W}_{4 , 4} & {φ}_{4} {W}_{4 , 2}\end{matrix} ] .$$

In this implementation, identical codewords may make a total number of codewords in the obtained codebook small, which can reduce a signaling overhead.

In some other implementations, two different fully-coherent transmission codewords for four layers using the four antenna ports may be selected as first candidate codeword, and two different fully-coherent transmission codewords for four layers using the four antenna ports are marked as W_{4,4} and W_{4,4}′ W_{4,4} and W_{4,4}′ may be concatenated in the row dimension to obtain [W_{4,4} W_{4,4}′]^{T}, which is the second concatenated codeword.

Optionally, two different fully-coherent transmission codewords for L−4 layers using the four antenna ports are determined as second candidate codeword. For example, two different fully-coherent transmission codewords for L−4 layers using the four antenna ports are marked as W_{4,L-4} and W_{4,L-4}′, and W_{4,L-4} and W_{4,L-4}′ may be concatenated in the row dimension to obtain [W_{4,L-4} W_{4,L-4}′]^{T}, which is the third concatenated codeword.

The fully-coherent transmission codewords for the L layers using the eight antenna ports are

$${W}_{8 , L} = [ \begin{matrix}{φ}_{1} {W}_{4 , 4} & {φ}_{2} {W}_{4 , L - 4} \\ {φ}_{3} {W}_{4 , 4}^{′} & {φ}_{4} {W}_{4 , L - 4}^{′}\end{matrix} ] ,$$

For example, the fully-coherent transmission codewords for six layers using the eight antenna ports may be composed of two different fully-coherent transmission codewords for four layers using the four antenna ports and two different fully-coherent transmission codewords for two layers using the four antenna ports, that is,

$${W}_{8 , 6} = [ \begin{matrix}{φ}_{1} {W}_{4 , 4} & {φ}_{2} {W}_{4 , 2} \\ {φ}_{3} {W}_{4 , 4}^{′} & {φ}_{4} {W}_{4 , 2}^{′}\end{matrix} ] .$$

In this implementation, different codewords may make a total number of codewords in the obtained codebook large, which can improve transmission performance.

In the present application, high-dimensional fully-coherent transmission codewords for the L layers using the eight antenna ports are constructed based on low-dimensional fully-coherent transmission codewords, so that transmission requirements of layer 1 to layer 8 using the eight antenna ports is supported for the uplink MIMO, hence, uplink MIMO technology is further enhanced.

It is to be noted that the above embodiments may be performed individually or in any combination, and the above embodiments may be performed by a network-side device (e.g., a base station). In an implementation, the above embodiments are performed by a network-side device (e.g., a base station), and the network-side device (e.g., a base station) transmits a finally determined codeword to a UE.

In some possible implementations, the above embodiments may also be performed by a user equipment (UE). Further, the UE sends the finally determined codeword to a network-side device (e.g., a base station).

In some other possible implementations, the above embodiments may also be performed by a network-side device (e.g., a base station) and a user equipment (UE), respectively.

The method for determining the fully-coherent transmission codewords for the L layers using the eight antenna ports for the uplink MIMO transmission according to the above embodiments may be applied to a terminal device and a network device. After the fully-coherent transmission codewords are determined, a precoding codebook may be determined based on the fully-coherent transmission codewords, and the terminal device and the network device may perform PUSCH transmission based on the precoding codebook.

The process of codebook-based uplink transmission (such as PUSCH transmission) is explained below.

Referring to FIG. 11, FIG. 11 is a schematic flowchart of an uplink transmission method according to an embodiment of the present application. The method is performed by a terminal device. As shown in FIG. 11, the method may include, but is not limited to, the following steps.

S1101: precoding matrix indicator information sent by a network device is received.

It is to be noted that in the PUSCH transmission process based on the precoding codebook, the network device may send transmit precoding matrix indicator (TPMI) information to the terminal device, where the precoding matrix indicator information carries precoding codebook design information, and accordingly, the terminal device may receive the precoding indicator information sent by the network device.

The TPMI is configured to indicate one target codeword in the precoding matrix.

S1102: a target codeword corresponding to uplink transmission is determined from the precoding codebook of L layers using the eight antenna ports for the uplink MIMO transmission based on the precoding matrix indicator information.

It is to be noted that the terminal device may determine, based on TPMI, a target codeword corresponding to uplink transmission from a precoding codebook of L layers using the eight antenna ports that corresponds to the uplink MIMO transmission. It is to be noted that the precoding codebook corresponding to the uplink MIMO transmission includes the fully-coherent transmission codewords for the L layers using the eight antenna ports that are determined in the above embodiments. For the process of determining the fully-coherent transmission codewords for the L layers using the eight antenna ports, reference may be made to the description of the relevant contents in the above embodiments, which will not be repeated here.

The terminal device may determine one target codeword from the precoding codebook based on the TPMI. Optionally, a mapping relationship between a codeword and an index may be preset, and a target codeword for uplink transmission may be determined from the precoding codebook according to the index.

S1103: the PUSCH is precoded based on the target codeword and the precoded PUSCH is sent to the network device.

After the target codeword is obtained, the PUSCH may be precoded based on the target codeword, and the precoded PUSCH may be sent to the network device.

In an embodiment of the present application, the precoding matrix indicator information sent by the network device is received, the target codeword corresponding to uplink transmission is determined from the precoding codebook of the L layers using the eight antenna ports for the uplink MIMO transmission based on the precoding matrix indicator information, and the PUSCH is precoded based on the target codeword and sent to the network device. In the present application, high-dimensional fully-coherent transmission codewords for the L layers using the eight antenna ports are constructed based on low-dimensional antenna fully-coherent transmission codewords, so that transmission requirements of layer 1 to layer 8 using the eight antenna ports is supported for the uplink MIMO, hence, uplink MIMO technology is further enhanced.

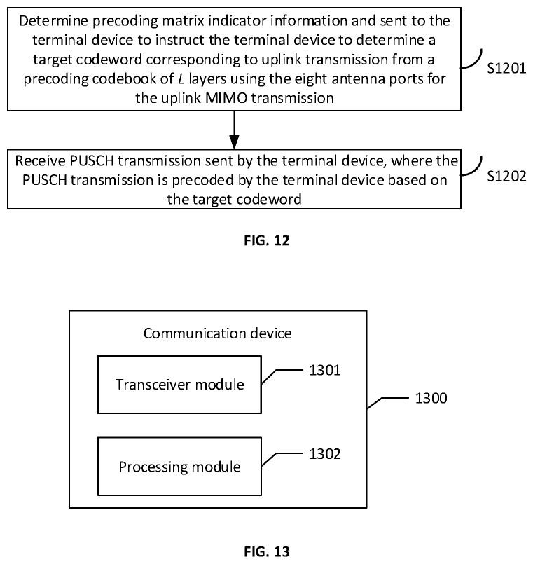

Referring to FIG. 12, FIG. 12 is a schematic flowchart of an uplink transmission method according to an embodiment of the present application. The method is performed by a network device. As shown in FIG. 12, the method may include, but is not limited to, the following steps.

S1201: precoding matrix indicator information is determined and sent to the terminal device to instruct the terminal device to determine a target codeword corresponding to uplink transmission from a precoding codebook of L layers using the eight antenna ports for the uplink MIMO transmission.

In an embodiment of the present application, the network device may receive a sounding reference signals (SRS) resource sent by the terminal device, perform channel evaluation based on the SRS resource, determine a TPMI based on an estimated channel status, and send the TPMI to the terminal device. The TPMI is configured to indicate one codeword in the precoding matrix, and may be an index of the codeword.

It is to be noted that the precoding codebook corresponding to the uplink MIMO transmission includes the fully-coherent transmission codeword based using 8Tx in the above embodiments. For a process of determining the fully-coherent transmission codewords for the L layers using the eight antenna ports, reference may be made to the description of the relevant contents in the above embodiments, which will not be repeated here.

S1202: PUSCH transmission sent by the terminal device is received, where the PUSCH transmission is precoded by the terminal device based on the target codeword.

After receiving the TPMI, the terminal device may obtain the target codeword used for uplink transmission, precode the PUSCH based on the target codeword, and send the precoded PUSCH to the network device. Accordingly, the network device may receive PUSCH transmission sent by the terminal device.

In an embodiment of the present application, the precoding matrix indicator information is determined, and the precoding matrix indicator information is sent to the terminal device to instruct the terminal device to determine the target codeword corresponding to uplink transmission from the precoding codebook of the L layers using the eight antenna ports for the uplink MIMO transmission, and PUSCH transmission sent by the terminal device is received, where PUSCH transmission is precoded by the terminal device based on the target codeword. In the present application, high-dimensional fully-coherent transmission codewords for the L layers using the eight antenna ports are constructed based on low-dimensional fully-coherent transmission codewords, so that transmission requirements of layer 1 to layer 8 using the eight antenna ports is supported for the uplink MIMO, hence, uplink MIMO technology is further enhanced.

In the above embodiments provided in the present application, the methods provided in the embodiments of the present application are described from the perspective of the network device and the terminal device separately. In order to implement the functions in the methods provided in the above embodiments of the present application, the network device and a first terminal device may include a hardware structure and a software module, and the above functions are implemented in a form of the hardware structure, the software module, or the hardware structure plus the software module. Certain function in above functions may be performed in a manner of the hardware structure, the software module, or the hardware structure plus the software module.

Referring to FIG. 13, FIG. 13 is a schematic structural diagram of a first communication device 1300 according to an embodiment of the present application. The first communication device 1300 shown in FIG. 13 may include a transceiver module 1301 and a processing module 1302. The transceiver module 1301 may include a transmitting module and/or a receiving module. The transmitting module is configured to implement a transmitting function, and the receiving module is configured to implement a receiving function. The transceiver module 1301 may implement a transmitting function and/or a receiving function.

The first communication device 1300 may be a terminal device, a device in the terminal device, or a device capable of being used together with the terminal device. Or, the first communication device 1300 may be a network device, a device in the network device, or a device capable of being used together with the network device.

The processing module 1302 is configured to determine a first candidate codeword and a second candidate codeword from the candidate codebook of the fully-coherent transmission using the four antenna ports for the uplink MIMO transmission; determine, based on orthogonality of candidate codewords in the candidate codebook, a constraint condition that a common phase coefficient needs to meet, and determine the common phase coefficient based on the constraint condition; and the fully-coherent transmission codewords for the L layers using the eight antenna ports for the uplink MIMO transmission are determined by concatenating the first candidate codeword and the second candidate codeword according to the common phase coefficient, where L is a positive integer and is less than or equal to 8.

In some implementations, the processing module 1302 is further configured to: in a case where 1≤L≤4, determine fully-coherent transmission codewords for the L layers using the four antenna ports from the candidate codebook as the first candidate codeword and the second candidate codeword.

In some implementations, the processing module 1302 is further configured to: in a case where 4<L≤8, determine fully-coherent transmission codewords for ┌L/2┐ layers using the four antenna ports from the candidate codebook as the first candidate codeword; and select vectors of └L/2┘ layers from the first candidate codeword to generate the second candidate codeword.

In some implementations, the processing module 1302 is further configured to: in a case where 4<L≤8, determine fully-coherent transmission codewords for ┌L/2┐ layers using the four antenna ports from the candidate codebook as the first candidate codeword; and determine fully-coherent transmission codewords for the └L/2┘ layers using the four antenna ports from the candidate codebook as the second candidate codeword.

In some implementations, the processing module 1302 is further configured to: in a case where 4<L≤8, determine fully-coherent transmission codewords for four layers using the four antenna ports from the candidate codebook as the first candidate codeword and the second candidate codeword.

In some implementations, the processing module 1302 is further configured to: obtain fully-coherent transmission codewords for eight layers using the eight antenna ports by concatenating the first candidate codeword and the second candidate codeword according to the common phase coefficient; and generate the fully-coherent transmission codewords for the L layers using the eight antenna ports by selecting L column vectors from the fully-coherent transmission codewords for eight layers using the eight antenna ports.

In some implementations, the processing module 1302 is further configured to: in a case where 4<L≤8, determine fully-coherent transmission codewords for four layers using the four antenna ports from the candidate codebook as the first candidate codeword; and determine fully-coherent transmission codewords for L−4 layers using the four antenna ports from the candidate codebook as the second candidate codeword.

In some implementations, the processing module 1302 is further configured to: determine, in a case where 1≤L≤4, a first common phase coefficient matrix according to the common phase coefficient; generate a first concatenated codeword by concatenating the first candidate codeword and the second candidate codeword in a row dimension; and generate the fully-coherent transmission codewords for the L layers using the eight antenna ports by performing Hadamard product operation on the first common phase coefficient matrix and the first concatenated codeword.

In some implementations, the processing module 1302 is further configured to: in a case where 4<L≤8, determine a second common phase coefficient matrix according to the common phase coefficient; generate a second concatenated codeword by concatenating two first candidate codewords in a row dimension; generate a third concatenated codeword by concatenating two second candidate codewords in the row dimension; generate a fourth concatenated codeword by concatenating the second concatenated codeword and the third concatenated codeword in a column dimension; and generate the fully-coherent transmission codewords for the L layers using the eight antenna ports by performing Hadamard product operation on the second common phase coefficient matrix and the fourth concatenated codeword.

In some implementations, the constraint condition is

$${φ}_{1}^{*} {φ}_{2} + {φ}_{3}^{*} {φ}_{4} = 0 ,$$

where φ₁, φ₂, φ₃, and φ₄ are the common phase coefficients.

In some implementations, the processing module 1302 is further configured to: determine a combination table of candidate common phase coefficients under the constraint condition and a set condition of φ₁; and determine, based on the combination table, the common phase coefficient used for concatenation.

In some implementations, the processing module 1302 is further configured to: determine a value of a first coefficient in φ₂, φ₃, and φ₄ based on the combination table; determine candidate values of another coefficient, i.e., a second coefficient, in φ₂, φ₃, and φ₄ according to the first coefficient; determine candidate values of a third coefficient in φ₂, φ₃, and φ₄ according to the first coefficient, the second coefficient, and the constraint condition, to generate a first combination sub-table; and determine the common phase coefficient from the first combination sub-table.

In some implementations, the value of the first coefficient occupies two bits for indication.

In some implementations, the processing module 1302 is further configured to: determine a value range of two coefficients based on the combination table, where the two coefficients are two of φ₂, φ₃, and φ₄, and the value range comprises two candidate values; determine values of the two coefficients based on the two candidate values; generate a second combination sub-table by determining a value of a remaining coefficient based on the values of the two coefficients and the constraint condition, where the remaining coefficient is the remaining one of φ₂, φ₃, and φ₄; and determine the common phase coefficient from the second combination sub-table.

In some implementations, the values of the two coefficients each occupy one bit for indication.

In some implementations, the processing module 1302 is further configured to: determine an energy normalization coefficient corresponding to a codeword, and perform energy normalization processing on the codeword based on the energy normalization coefficient.

In the present application, high-dimensional fully-coherent transmission codewords for the L layers using the eight antenna ports are constructed based on low-dimensional fully-coherent transmission codewords, so that transmission requirements of layer 1 to layer 8 using the eight antenna ports is supported for the uplink MIMO, hence, uplink MIMO technology is further enhanced.

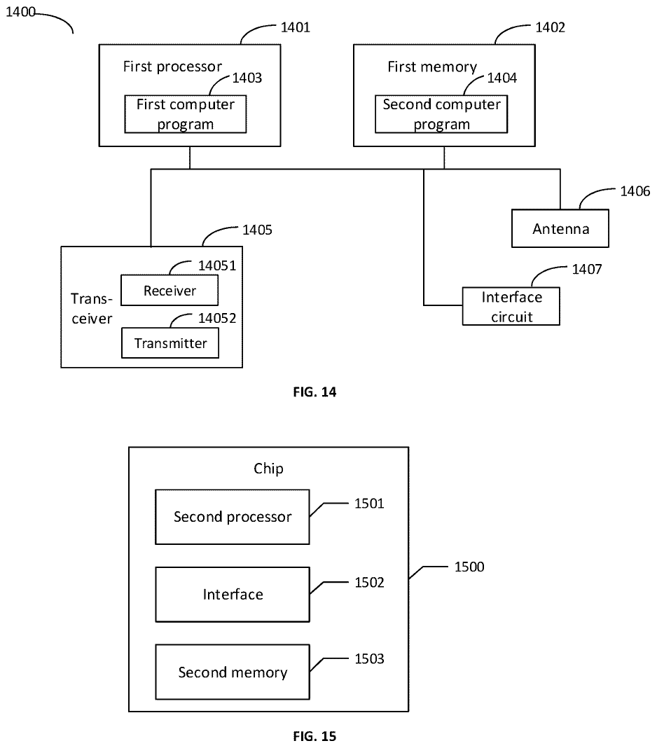

Referring to FIG. 14, FIG. 14 is a schematic structural diagram of a second communication device 1400 according to another embodiment of the present application. The second communication device 1400 may be a network device, or a terminal device, or a chip, chip system, or processor that supports the network device to implement the above method, or a chip, system on chip, or processor that supports the terminal device to implement the above method. The device may be configured to implement the method described in the above method embodiments. For details, reference may be made to the above method embodiments.

The second communication device 1400 may include one or more first processors 1401. The first processor 1401 may be a general-purpose processor or a dedicated processor, such as a baseband processor or a central processing unit. The baseband processor may be configured to process a communication protocol and communication data. The central processing unit may be configured to control a communication device (e.g., a base station, a baseband chip, a terminal device, a terminal device chip, a DU or CU), execute a computer program, and process data of the computer program.

Optionally, the second communication device 1400 may further include one or more first memories 1402 on which a second computer program 1404 may be stored. The first processor 1401 executes the second computer program 1404 to cause the second communication device 1400 to perform the methods described in the above method embodiments. Optionally, the first memory 1402 may further have data stored therein. The second communication device 1400 and the first memory 1402 may be arranged separately or integrated together.

Optionally, the second communication device 1400 may further include a transceiver 1405 and an antenna 1406. The transceiver 1405 may be referred to as a transceiver unit, a transceiver machine, or a transceiver circuit, to implement a transceiver function. The transceiver 1405 may include a receiver 14051 and a transmitter 14052. The receiver 14051 may be referred to as a receiver machine or a receiver circuit, to implement a receiving function, and the transmitter 14052 may be referred to as a transmitter machine or a transmitter circuit, to implement a transmitting function.

Optionally, the second communication device 1400 may further include one or more interface circuits 1407. The interface circuit 1407 is configured to receive code instructions and transmit the code instructions to the first processor 1401. The first processor 1401 runs the code instructions to cause the second communication device 1400 to perform the methods described in the above method embodiments.

The second communication device 1400 is a terminal device that may be used to perform the functions of the terminal device in the above embodiments.

The second communication device 1400 is a network device that may be used to perform the functions of the terminal device in the above embodiments.

In an implementation, the first processor 1401 may include a transceiver configured to implement receiving and transmitting functions. For example, the transceiver may be a transceiver circuit, or interface, or interface circuit. The transceiver circuit, interface, or interface circuit configured to implement the receiving and transmitting functions may be arranged separately or integrated together. The above transceiver circuit, interface, or interface circuit may be configured to read and write a code/data, or the above transceiver circuit, interface, or interface circuit may be configured to transmit or transfer a signal.

In an implementation, the first processor 1401 may store a first computer program 1403. The first computer program 1403 may be run on the first processor 1401 to cause the second communication device 1400 to perform the methods described in the above method embodiments. The first computer program 1403 may be solidified in the first processor 1401. In this case, the first processor 1401 may be implemented by hardware.

In an implementation, the second communication device 1400 may include a circuit. The circuit may implement the functions of transmitting, receiving, or communicating in the above method embodiments. The processor and transceiver described in the present application may be implemented on an integrated circuit (IC), an analog IC, a radio frequency integrated circuit (RFIC), a mixed signal IC, an application specific integrated circuit (ASIC), a printed circuit board (PCB), an electronic device, etc. The processor and transceiver may also be manufactured using various IC process technologies such as a complementary metal oxide semiconductor (CMOS), a negative channel metal oxide semiconductor (NMOS), a positive channel metal oxide semiconductor (PMOS), a bipolar junction transistor (BJT), a bipolar CMOS (BiCMOS), a silicon germanium (SiGe), and gallium arsenide (GaAs).

The communication device described in the above embodiments may be a network device or a terminal device, but the scope of the communication device described in the present application is not limited thereto, and the structure of the communication device may not be limited by FIG. 14. The communication device may be an independent device or may be part of a larger device. For example, the communication device may be:
(1) an independent integrated circuit (IC), or chip, or system or subsystem on chip;
(2) a set of one or more ICs, where optionally, the set of ICs may include storage components for storing data and computer programs;
(3) an ASIC, such as a Modem;
(4) a module that may be embedded into other devices;
(5) a receiver, a terminal device, an intelligent terminal device, a cellular phone, a wireless device, a handheld device, a mobile unit, a vehicle-mounted device, a network device, a cloud device, an artificial intelligence device, etc.; and
(6) others, etc.

In a case where the communication device may be a chip or a system on chip, reference may be made to the schematic structural diagram of a chip shown in FIG. 15. The chip 1500 shown in FIG. 15 includes a second processor 1501 and an interface 1502. A number of processors 1501 may be one or more, and a number of interfaces 1502 may be more than one.

The second processor 1501 is configured to determine a first candidate codeword and a second candidate codeword from the candidate codebook of the fully-coherent transmission using the four antenna ports for the uplink MIMO transmission; determine, based on orthogonality of candidate codewords in the candidate codebook, a constraint condition that a common phase coefficient needs to meet, and determine the common phase coefficient based on the constraint condition; and determine the fully-coherent transmission codewords for the L layers using the eight antenna ports for the uplink MIMO transmission by concatenating the first candidate codeword and the second candidate codeword according to the common phase coefficient, where L is a positive integer and is less than or equal to 8.

In some implementations, the second processor 1501 is further configured to: in a case where 1≤L≤4, determine fully-coherent transmission codewords for the L layers using the four antenna ports from the candidate codebook as the first candidate codeword and the second candidate codeword.

In some implementations, the second processor 1501 is further configured to: in a case where 4<L≤8, determine fully-coherent transmission codewords for ┌L/2┐ layers using the four antenna ports from the candidate codebook as the first candidate codeword; and select vectors of └L/2┘ layers from the first candidate codeword to generate the second candidate codeword.

In some implementations, the second processor 1501 is further configured to: in a case where 4<L≤8, determine fully-coherent transmission codewords for ┌L/2┐ layers using the four antenna ports from the candidate codebook as the first candidate codeword; and determine fully-coherent transmission codewords for └L/2┘ layers using the four antenna ports from the candidate codebook as the second candidate codeword.

In some implementations, the second processor 1501 is further configured to: in a case where 4<L≤8, determine fully-coherent transmission codewords for four layers using the four antenna ports from the candidate codebook as the first candidate codeword and the second candidate codeword.

In some implementations, the second processor 1501 is further configured to: obtain fully-coherent transmission codewords for eight layers using the eight antenna ports by concatenating the first candidate codeword and the second candidate codeword according to the common phase coefficient; and generate the fully-coherent transmission codewords for the L layers using the eight antenna ports by selecting L column vectors from the fully-coherent transmission codewords for eight layers using the eight antenna ports.

In some implementations, the second processor 1501 is further configured to: in a case where 4<L≤8, determining fully-coherent transmission codewords for four layers using the four antenna ports from the candidate codebook as the first candidate codeword; and determine fully-coherent transmission codewords for L−4 layers using the four antenna ports from the candidate codebook as the second candidate codeword.

In some implementations, the second processor 1501 is further configured to: in a case where 1≤L≤4, determine a first common phase coefficient matrix according to the common phase coefficient; generate a first concatenated codeword by concatenating the first candidate codeword and the second candidate codeword in a row dimension; and generate the fully-coherent transmission codewords for the L layers using the eight antenna ports by performing Hadamard product operation on the first common phase coefficient matrix and the first concatenated codeword.

In some implementations, the second processor 1501 is further configured to: in a case where 4<L≤8, determine a second common phase coefficient matrix according to the common phase coefficient; concatenate two first candidate codewords in the row dimension to generate a second concatenated codeword; concatenate two second candidate codewords in the row dimension to generate a third concatenated codeword; concatenate the second concatenated codeword and the third concatenated codeword in a column dimension to generate a fourth concatenated codeword; and perform Hadamard product operation on the second common phase coefficient matrix and the fourth concatenated codeword to generate the fully-coherent transmission codewords for the L layers using the eight antenna ports.

In some implementations, the constraint condition is

$${φ}_{1}^{*} {φ}_{2} + {φ}_{3}^{*} {φ}_{4} = 0 ,$$

where φ₁, φ₂, φ₃, and φ₄ are the common phase coefficients.

In some implementations, the second processor 1501 is further configured to: determine a combination table of candidate common phase coefficients under the constraint condition and a set condition of φ₁; and determine, based on the combination table, the common phase coefficient used for concatenation.

In some implementations, the second processor 1501 is further configured to: determine a value of a first coefficient in φ₂, φ₃ and φ₄ based on the combination table; determine candidate values of another coefficient, i.e., a second coefficient, in φ₂, φ₃, and φ₄ according to the first coefficient; determine candidate values of a third coefficient in φ₂, φ₃, and φ₄ according to the first coefficient, the second coefficient, and the constraint condition, to generate a first combination sub-table; and determine the common phase coefficient from the first combination sub-table.

In some implementations, the value of the first coefficient occupies two bits for indication.

In some implementations, the second processor 1501 is further configured to: determine a value range of two coefficients in φ₂, φ₃, and φ₄ based on the combination table, where the value range includes two candidate values; determine values of the two coefficients based on the two candidate values; determine a value of the remaining coefficient in φ₂, φ₃, and φ₄ based on the values of the two coefficients and the constraint condition, to generate a second combination sub-table; and determine the common phase coefficient from the second combination sub-table.

In some implementations, the values of the two coefficients each occupy one bit for indication.

In some implementations, the second processor 1501 is further configured to determine an energy normalization coefficient corresponding to a codeword, and perform energy normalization processing on the codeword based on the energy normalization coefficient.

The chip 1500 further includes a second memory 1503 configured to store a necessary computer program and data.

As used herein, the term processor may refer to one processor that performs the defined functions or a plurality of processors that collectively perform defined functions, such that the execution of the individual defined functions may be divided amongst such processors.

In the present application, high-dimensional fully-coherent transmission codewords for the L layers using the eight antenna ports are constructed based on low-dimensional fully-coherent transmission codewords, so that transmission requirements of layer 1 to layer 8 using the eight antenna ports is supported for the uplink MIMO, hence, uplink MIMO technology is further enhanced.

A person skilled in the art may also understand that the various illustrative logical blocks and steps listed in the embodiments of the present application may be implemented by electronic hardware, computer software, or a combination thereof. Whether such functions are implemented by hardware or software depends on the specific application and design requirements of the whole system. A person skilled in the art may use various methods to implement the described functions for each specific application, but such implementation should not be understood as exceeding the protection scope of the embodiments of the present application.

An embodiment of the present application further provides a communication system. The system includes a communication device as a terminal device and a communication device as a network device in the above embodiment of FIG. 8, or, the system includes a communication device as a terminal device and a communication device as a network device in the above embodiment of FIG. 9.

The present application further provides a readable storage medium on which instructions are stored. The instructions, when executed by a computer, implement the functions of any one of the above method embodiments.

The present application further provides a computer program product. The computer program product, when executed by a computer, performs the functions of any one of the above method embodiments.

In the above embodiments, the functions may be fully or partially implemented by software, hardware, firmware, or any combination thereof. When implemented by the software, the functions may be fully or partially implemented in a form of a computer program product. The computer program product includes one or more computer programs. When the computer program are loaded and executed on the computer, all or part of the processes or functions described in the embodiments of the present application are generated. The computer may be a general-purpose computer, a dedicated computer, a computer network, or another programmable device. The computer program may be stored in a non-transitory computer-readable storage medium or transmitted from one non-transitory computer-readable storage medium to another. For example, the computer program may be transmitted from one website, computer, server, or data center to another site website, computer, server, or data center through wired (such as coaxial cable, fiber optic, or digital subscriber line (DSL)) or wireless (such as infrared, wireless, or microwave) methods. The non-transitory computer-readable storage medium may be any available medium that a computer can access or a data storage device such as a server or data center that includes one or more available media integrated. The available medium may be a magnetic medium (such as a floppy disk, a hard disk, a magnetic tape), an optical medium (such as a high-density digital video disc (DVD)), or a semiconductor medium (such as a solid state disk (SSD)), etc.

A person of ordinary skill in the art may understand that first, second, and other numerical numbers involved in the present application are merely for convenience of description and differentiation, rather than limiting the scope of the embodiments of the present application, and also indicate an order.

At least one in the present application may also be described as one or more, and a plurality of may be two, three, four, or more, which is not limited in the present application. In the embodiments of the present application, for a kind of technical feature, technical features in the kind of technical feature are distinguished by “first”, “second”, “third”, “A”, “B”, “C”, “D”, etc. The technical features described by “first”, “second”, “third”, “A”, “B”, “C”, and “D” do not have any order of sequence or magnitude.

The correspondences shown in each table in the present application may be configured or predefined. The values of information in each table are merely examples and may be configured as other values, which is not limited in the present application. When a correspondence between information and various parameters is configured, it is not necessary to configure all the correspondences shown in each table. For example, in the tables in the present application, the correspondences shown in some rows may not be configured. For another example, appropriate deformation adjustments, such as splitting and merging, may be made based on the above tables. Names of the parameters shown in titles in the above tables may also be other names understandable by the communication device, and the values or representations of the parameters may be other values or representations understandable by the communication device. The above tables may also be implemented using other data structures, such as arrays, queues, containers, stacks, linear tables, pointers, linked lists, trees, graphs, structures, classes, heaps, hash tables, or hash tables.

Predefined in the present application may be understood as defined, predefined, stored, prestored, prenegotiated, preconfigured, solidified, or prefired.

A person of ordinary skill in the art may realize that the units and algorithm steps of each example described in combination with the embodiments disclosed herein may be implemented in electronic hardware, or a combination of computer software and the electronic hardware. Whether these functions are executed in hardware or software depends on the specific application and design constraint condition of the technical solution. A person skilled in the art may use different methods to implement the described functions for each specific application, but such implementation should not be taken into account beyond the scope of the present application.

A person skilled in the art can clearly understand that for the convenience and brevity of the description, for the specific working processes of the system, device, and unit described above, reference may be made to the corresponding processes in the above method embodiments, which will not be repeated here.

The above descriptions are merely specific implementations of the present application, but the protection scope of the present application is not limited thereto. Any modification or replacement that may be readily figured out by any person skilled in the art within the technical scope disclosed in the present application shall fall within the protection scope of the present application. Therefore, the protection scope of the present application is to be subject to the protection scope of the claims.

1. A method for determining a fully-coherent transmission codebook for uplink multiple input multiple output (MIMO) transmission, comprising:
determining a first candidate codeword and a second candidate codeword from a candidate codebook of fully-coherent transmission using four antenna ports for the uplink MIMO transmission;
determining, based on orthogonality of candidate codewords in the candidate codebook, a constraint condition that a common phase coefficient needs to meet;
determining the common phase coefficient based on the constraint condition; and
determining, by concatenating the first candidate codeword and the second candidate codeword according to the common phase coefficient, fully-coherent transmission codewords for L layers using eight antenna ports for the uplink MIMO transmission, wherein L is a positive integer and is less than or equal to 8.

2. The method according to claim 1, wherein determining the first candidate codeword and the second candidate codeword from the candidate codebook of the fully-coherent transmission using the four antenna ports for the uplink MIMO transmission comprises:
determining fully-coherent transmission codewords for the L layers using the four antenna ports from the candidate codebook as the first candidate codeword and the second candidate codeword, in a case where 1≤L≤4.

3. The method according to claim 1, wherein determining the first candidate codeword and the second candidate codeword from the candidate codebook of the fully-coherent transmission using the four antenna ports for the uplink MIMO transmission comprises:
determining, in a case where 4<L≤8, fully-coherent transmission codewords for ┌L/2┐ layers using the four antenna ports from the candidate codebook as the first candidate codeword; and
selecting vectors of └L/2┘ layers from the first candidate codeword to generate the second candidate codeword.

4. The method according to claim 1, wherein determining the first candidate codeword and the second candidate codeword from the candidate codebook of the fully-coherent transmission using the four antenna ports for the uplink MIMO transmission comprises:
determining, in a case where 4<L≤8, fully-coherent transmission codewords for ┌L/2┐ layers using the four antenna ports from the candidate codebook as the first candidate codeword; and
determining fully-coherent transmission codewords for └L/2┘ layers using the four antenna ports from the candidate codebook as the second candidate codeword.

5. The method according to claim 1, wherein determining the first candidate codeword and the second candidate codeword from the candidate codebook of the fully-coherent transmission using the four antenna ports for the uplink MIMO transmission comprises:
determining, in a case where 4<L≤8, fully-coherent transmission codewords for four layers using the four antenna ports from the candidate codebook as the first candidate codeword and the second candidate codeword.

6. The method according to claim 5, wherein determining, by concatenating the first candidate codeword and the second candidate codeword according to the common phase coefficient, the fully-coherent transmission codewords for the L layers using the eight antenna ports for the uplink MIMO transmission comprises:
obtaining, by concatenating the first candidate codeword and the second candidate codeword according to the common phase coefficient, the fully-coherent transmission codewords for eight layers using the eight antenna ports; and
generating, by selecting L column vectors from the fully-coherent transmission codewords for the eight layers using the eight antenna ports, fully-coherent transmission codewords for the L layers using the eight antenna ports.

7. The method according to claim 1, wherein determining the first candidate codeword and the second candidate codeword from the candidate codebook of the fully-coherent transmission using the four antenna ports for the uplink MIMO transmission comprises:
determining, in a case where 4<L≤8, fully-coherent transmission codewords for four layers using the four antenna ports from the candidate codebook as the first candidate codeword; and
determining fully-coherent transmission codewords for L−4 layers using the four antenna ports from the candidate codebook as the second candidate codeword.

8. The method according to claim 1, wherein determining, by concatenating the first candidate codeword and the second candidate codeword according to the common phase coefficient, the fully-coherent transmission codewords for the L layers using the eight antenna ports for the uplink MIMO transmission comprises:
determining, in a case where 1<L≤4, a first common phase coefficient matrix according to the common phase coefficient;
generating a first concatenated codeword by concatenating the first candidate codeword and the second candidate codeword in a row dimension; and
generating the fully-coherent transmission codewords for the L layers using the eight antenna ports by performing Hadamard product operation on the first common phase coefficient matrix and the first concatenated codeword.

9. The method according to claim 1, wherein determining, by concatenating the first candidate codeword and the second candidate codeword according to the common phase coefficient, the fully-coherent transmission codewords for the L layers using the eight antenna ports for the uplink MIMO transmission comprises:
determining, in a case where 4<L≤8, a second common phase coefficient matrix according to the common phase coefficient;
generating, by concatenating two first candidate codewords in a row dimension, a second concatenated codeword;
generating, by concatenating two second candidate codewords in the row dimension, a third concatenated codeword;
generating, by concatenating the second concatenated codeword and the third concatenated codeword in a column dimension, a fourth concatenated codeword; and
generating, by performing Hadamard product operation on the second common phase coefficient matrix and the fourth concatenated codeword, the fully-coherent transmission codewords for the L layers using the eight antenna ports.

10. The method according to claim 1, wherein the constraint condition is
$${φ}_{1}^{*} {φ}_{2} + {φ}_{3}^{*} {φ}_{4} = 0 ,$$
wherein φ₁, φ₂, φ₃, and φ₄ are the common phase coefficients.

11. The method according to claim 10, wherein determining the common phase coefficient based on the constraint condition comprises:
determining a combination table of candidate common phase coefficients under the constraint condition and a set condition of φ₁; and
determining, based on the combination table, the common phase coefficient for concatenation.

12. The method according to claim 11, wherein determining, based on the combination table, the common phase coefficient for concatenation comprises:
determining a value of a first coefficient based on the combination table, wherein the first coefficient is one of φ₂, φ₃, and φ₄;
determining a candidate value of a second coefficient according to the first coefficient, wherein the second coefficient is one of φ₂, φ₃, and φ₄ other than the first coefficient;
generating a first combination sub-table by determining a candidate value of a third coefficient according to the first coefficient, the second coefficient, and the constraint condition, wherein the third coefficient is one of φ₂, φ₃, and φ₄ other than the first coefficient and the second coefficient; and
determining the common phase coefficient from the first combination sub-table.

13. The method according to claim 12, wherein the value of the first coefficient occupies two bits for indication.

14. The method according to claim 11, wherein determining, based on the combination table, the common phase coefficient for concatenation comprises:
determining a value range of two coefficients based on the combination table, wherein the two coefficients are two of φ₂, φ₃, and φ₄, and the value range comprises two candidate values;
determining values of the two coefficients based on the two candidate values;
generating a second combination sub-table by determining a value of a remaining coefficient based on the values of the two coefficients and the constraint condition, wherein the remaining coefficient is the remaining one of φ₂, φ₃, and φ₄; and
determining the common phase coefficient from the second combination sub-table.

15. The method according to claim 14, wherein the values of the two coefficients each occupy one bit for indication.

16. The method according to claim 1, further comprising:
determining an energy normalization coefficient corresponding to a codeword; and
performing energy normalization processing on the codeword based on the energy normalization coefficient.

17. (canceled)

18. A communication device, comprising:
one or more processors; and
a memory that stores a computer program,
wherein the one or more processors are collectively configured to executes the computer program stored in the memory to cause the communication device to perform:
determining a first candidate codeword and a second candidate codeword from a candidate codebook of fully-coherent transmission using four antenna ports for uplink multiple input multiple output (MIMO) transmission;
determining, based on orthogonality of candidate codewords in the candidate codebook, a constraint condition that a common phase coefficient needs to meet;
determining the common phase coefficient based on the constraint condition; and
determining, by concatenating the first candidate codeword and the second candidate codeword according to the common phase coefficient, fully-coherent transmission codewords for L layers using eight antenna ports for the uplink MIMO transmission, wherein L is a positive integer and is less than or equal to 8.

19. A communication device, comprising:
one or more processors; and
an interface circuit, wherein
the interface circuit is configured to receive code instructions and transmit the code instructions to the one or more processors; and
one or more processors are collectively configured to run the code instructions to perform:
determining a first candidate codeword and a second candidate codeword from a candidate codebook of fully-coherent transmission using four antenna ports for uplink multiple input multiple output (MIMO) transmission;
determining, based on orthogonality of candidate codewords in the candidate codebook, a constraint condition that a common phase coefficient needs to meet;
determining the common phase coefficient based on the constraint condition; and
determining, by concatenating the first candidate codeword and the second candidate codeword according to the common phase coefficient, fully-coherent transmission codewords for L layers using eight antenna ports for the uplink MIMO transmission, wherein L is a positive integer and is less than or equal to 8.

20. A non-transitory computer-readable storage medium storing instructions, wherein the instructions, when executed, implement the method according to claim 1.

21. The communication device according to claim 18, wherein the one or more processors are collectively configured to execute the computer program stored in the memory to cause the communication device to perform:
determining fully-coherent transmission codewords for the L layers using the four antenna ports from the candidate codebook as the first candidate codeword and the second candidate codeword, in a case where 1≤L≤4.
